(19) United States
(12) Patent Application Publication
(10) Pub. No.: US 2025/0079774 A1
(43) Pub. Date: Mar. 6, 2025

(54) DOORS FOR HOME APPLIANCE AND HOME APPLIANCE INCLUDING THE SAME

(71) Applicant: LG ELECTRONICS INC., Seoul (KR)

(72) Inventor: DongWoo KIM, Seoul (KR)

(21) Appl. No.: 18/816,610

(22) Filed: Aug. 27, 2024

(30) Foreign Application Priority Data
Aug. 29, 2023 (KR) 10-2023-0113781

(51) Int. Cl. H01R 13/73; F24C 15/02

(52) U.S. Cl. CPC H01R 13/73; F24C 15/02

(57) ABSTRACT

A door for a home appliance includes a door body disposed in front of a storage space of a home appliance, and in which an electronic component is disposed. A connector module is disposed in the door body. The connector module includes a mounting base and a door connector to which a door wire is connected. The mounting base includes a wire guide covering the door wire and guiding an extension direction of the door wire. The door wire is guided by the wire guide provided in the door and extends in a specific direction in the door.

### CROSS REFERENCE TO RELATED APPLICATIONS

The present application claims priority to and the benefit of Korean Patent Application No. 10-2023-0113781, filed on Aug. 29, 2023, the disclosure of which is incorporated herein by reference in its entirety.

### TECHNICAL FIELD

The present disclosure relates to a door for a home appliance.

### BACKGROUND

Home appliances may store target objects and include doors. For example, home appliances include a cooking appliance, a refrigerator, a clothing treating apparatus, etc. The home appliances may include storage spaces for storing target objects in cabinets, creating the external appearance thereof, and doors to open and close the storage spaces.

Various electronic components may be installed in the door of the home appliance. For example, a touch sensor device, a display device, etc. may be installed in the door.

The electronic components may be electrically connected to a main controller provided in a main body of the home appliance with one or more wires.

To facilitate the connection of the wire, the wire may be connected to a connector. For example, a door connector protruding from the door and a main body connector protruding from the main body of the home appliance may be assembled with each other. As described above, the door connector and the main body connector (which is also referred to as “connector assembly” in this disclosure) are disposed not to be exposed outward. For example, the connector assembly is stored in a frame of the main body close to the door and a storage entrance may be covered with a separate cover.

For instance, assembling of the connector assembly may be performed after the door is assembled to the main body. After the door is assembled to the main body, the door connector may be assembled to the main body connector. However, a narrow gap between the door and the main body may make the assembly of the connectors difficult.

In some examples, regarding the home appliance, products such as cooking appliance that create high-temperature environments in a storage space cause the main bodies to be heated to high temperatures. As described above, the high temperature of the main body affects the connector assembly, reducing durability of the connector assembly and resulting in damage to the connector assembly.

In addition, the wire is made of a flexible material, so it is difficult to arrange the wire in the desired direction in the home appliance. When the wire is stored in the home appliance in a freely bent state, the wire may interfere with other components and may be exposed outwards.

Specifically, when the wire is disposed between relatively moved components such as the main body and the door of the home appliance, the wire is also pulled and moved. As described above, in the moving process, a direction of the wire may change continuously and deviate from a mounting position of the wire. Therefore, even when the wire is mounted in a component that is continuously operated, an extension direction of the wire may need to remain constant.

In addition, a wire installed in the main body of the home appliance and a wire installed in the door may be fixed by separate fasteners at regular intervals for assembly stability. As described above, the connectors provided at terminal ends of the wires fixed by the fasteners are limited in terms of movable distances and directions. When the wires are sufficiently long, the operational distance for coupling the connectors increases, which improves workability. However, long exposed sections of wires that extend outward deteriorate the aesthetics and reduces the durability, as the sheath may be damaged due to friction with the external part. On the other hand, when the wires are shortened, the sections where the wires are exposed outward are shortened, improving the aesthetics and reducing friction with the external part. However, there creates some issues as the workability of assembling the two connectors is reduced.

### SUMMARY

The present disclosure describes assembling of a wire and a connector connected to an electronic component disposed in a door with a relative connector (main body connector) and storing the assembly in the door.

Another objective of the present disclosure is to enable a wire to maintain a constant direction in a door even when the door is opened and closed, thereby preventing the wire from disrupting a window.

Yet another objective of the present disclosure is to move a connector along a constant path in a door, and to enable a wire to be bent only in a preset direction when the connector is moved.

The present disclosure further describes adjusting the storage depth of a connector in a door to respond to a variety of extra lengths of a wire.

Aspects of the present disclosure are not limited to the above-described ones. Additionally, other aspects and advantages that have not been mentioned can be clearly understood from the following description and can be more clearly understood from implementations. Further, it will be understood that the aspects and advantages of the present disclosure can be realized via means and combinations thereof that are described in the appended claims.

According to the features of the present disclosure to achieve the above-described objectives, each of doors for a home appliance of the present disclosure may include a door body disposed in front of a storage space of the home appliance and in which an electronic component is disposed. A connector module may be disposed in the door body. The connector module may include a mounting base and a door connector to which a door wire is connected. At this point, the mounting base may include a wire guide covering the door wire and guiding an extension direction of the door wire. Therefore, the door wire may be guided by the wire guide provided in the door and may extend in a specific direction in the door.

In addition, while the door connector may be moved along the mounting base, a relative direction to the wire guide may change. When the door wire extends in a specific direction, even when the door connector is moved, the door wire may not interfere with other components inside the door or disrupt the window of the door.

Furthermore, the wire guide may be disposed between the electronic component and the door connector. Accordingly, the door wire may extend between the electronic component and the door connector.

In addition, the wire guide may include a first guide protruding on a surface of the mounting base, and a second guide disposed closer to the electronic component than the first guide.

Furthermore, the first guide and the second guide may be disposed to be transversely spaced apart from each other in a transverse width direction of the door body.

In addition, the connector module may include a movement supporter movably disposed at the mounting base. The door connector may be assembled with the movement supporter and moved with the movement supporter.

Furthermore, the movement supporter may include a wire fixation part guiding the door wire. When the movement supporter is moved, a distance between the wire fixation part and the wire guide may change.

In addition, the wire fixation part and the first guide may be disposed on an imaginary central line extending in a movement direction of the door connector. The second guide may be disposed at a position deviating from the imaginary central line.

Furthermore, an angle between an imaginary first extension line connecting the wire fixation part and the first guide to each other and an imaginary second extension line connecting the first guide and the second guide to each other may be an acute angle.

In addition, a mounting station at which the door connector is moved may protrude from the mounting base. The first guide may be disposed at the mounting station. The second guide may be disposed outside the mounting station.

Furthermore, the second guide may be disposed closer to an edge of the door body than the first guide.

In addition, a first guide hole may be open on a central portion of the first guide, and the door wire passes through the first guide hole. A second guide hole may be open on a central portion of the second guide, and the door wire passes through the second guide hole. The first guide hole and the second guide hole may be open in different directions from each other.

Furthermore, the height of the first guide hole may be higher than the height of the second guide hole.

In addition, the first guide may consist of a pair of guide hooks that support opposite side surfaces of the door wire. The first guide hole may be formed between the pair of guide hooks.

Furthermore, a wire insertion port in which the door wire is inserted may be provided at one side portion of the second guide. The wire insertion port may be open in a direction toward the edge of the door body.

In addition, the electronic component may include a main unit extending in a first direction and a connection unit extending in a second direction different from the first direction. At this point, the connection unit may include a connection hole that is open toward the connector module. The door wire may extend from the wire guide toward the connection hole.

Furthermore, a door panel may be disposed at a central portion of the door body. The door panel may include a window through which the storage space is visible. An indoor space defined by the door body and the door panel may include an installation region around an outer portion of the window. The connector module may be disposed at the installation region.

In addition, the wire guide may include a first guide and a second guide spaced apart from each other.

Furthermore, the second guide may be disposed at a position relatively farther from the window than the first guide.

In addition, the wire guide may guide the door wire to be bent between the connector module and the electronic component.

As described above, the door for a home appliance and the home appliance including the same according to the present disclosure have the following effects.

In the present disclosure, the door connector connected to the electronic component in the door may be disposed in the door. The door wire connected to the door connector may also be disposed in the door with the door connector. Therefore, the door wire does not need to be disposed in a narrow space between the main body and the door, which has an effect of improving the workability for mounting of the door wire.

At this point, the door wire is guided by the wire guide provided in the door and may extend in a specific direction in the door. When the door wire extends in a specific direction, the door wire does not interfere with other components inside the door or does not disrupt the window of the door. Therefore, the aesthetic feeling of the door can be improved.

In addition, the door wire of the present disclosure may be guided by a plurality of wire guides. The plurality of wire guides may guide the door wire to be bent in a specific direction when the door connector is moved. Accordingly, even though the door connector is moved, the door wire can be prevented from being bent in an arbitrary direction, and storage performance of the door wire can be improved.

Furthermore, a part of the plurality of wire guides of the present disclosure may be disposed at positions close to edges of the door body. Accordingly, the door wire may be guided to face an edge of the door rather than the window. The door wire may naturally extend in a direction away from the window, and the door wire may be prevented from disrupting the window even without a separate fence.

In addition, the door connector of the present disclosure is disposed in the movement supporter and may be moved with the movement supporter along the mounting base. At this point, the movement supporter may also include the wire fixation part. The wire fixation part may fix one end portion of the door wire while being moved with the movement supporter. The wire fixation part may prevent bending of one end portion of the door wire where a force is applied first when the door connector is moved and may allow the door wire to be followed in a specific path. Therefore, mounting stability of the door wire can be improved.

In addition, in the present disclosure, a part of the electronic component (connection unit) disposed in the door may be disposed to face the door connector. The wire guide may guide the door wire to be followed in a path between a part of the electronic component and the door connector facing each other as described above. Therefore, the door wire can stably connect the door connector and the electronic component to each other without deviating from the path therebetween.

In addition, in the present disclosure, the door connector and the relative connector coupled thereto may be fixed to various positions by the storage fixation part provided along the connector storage portion. Accordingly, the mounting depth of the door connector and the relative connector can be varied, and a variety of extra lengths of the wires connected to the connectors can be accommodated. Therefore, the assembly compatibility of the connectors can be improved.

Furthermore, in the present disclosure, the connectors are stored in the door, not the main body of the home appliance. Accordingly, the connectors can be less affected by harsh environments of the main body in which the temperature and the humidity are excessively high or low. Accordingly, the durability of the connectors can be improved, and the operation reliability of the connectors can be improved.

### BRIEF DESCRIPTION OF THE DRAWINGS

FIG. 1 is a perspective view illustrating an embodiment of a home appliance according to the present disclosure.

FIG. 2 is a perspective view illustrating the embodiment of the present disclosure with a separated side cover constituting the embodiment.

FIG. 3 is a perspective view illustrating a lower door constituting the embodiment of the present disclosure.

FIG. 4 is an exploded perspective view illustrating main components of the lower door constituting the embodiment of the present disclosure.

FIG. 5 is a perspective view, in greater detail than FIG. 4, illustrating the main components of the lower door constituting the embodiment of the present disclosure.

FIG. 6 is a perspective view illustrating a structure of the lower door, an image acquisition module, a connector module, a main wire, and a connector wire constituting the embodiment of the present disclosure.

FIG. 7 is a perspective view illustrating the connector module constituting the embodiment of the present disclosure assembled at a lower portion of the lower door.

FIGS. 8A and 8B are perspective views illustrating the connector module constituting the embodiment of the present disclosure before and after being stored into the lower door.

FIG. 9 is a perspective view illustrating the internal part of the lower door without a rear frame and an inner frame of the lower door constituting the embodiment of the present disclosure.

FIG. 10 is a sectional view taken along line X-X′ of FIG. 9.

FIG. 11 is a perspective view illustrating an embodiment of the connector module constituting the door for a home appliance according to the present disclosure.

FIG. 12 is a perspective view illustrating the embodiment of the connector module according to the present disclosure in a mounted state to the lower door, without the lower door.

FIG. 13 is a perspective view illustrating a movement supporter and a door connector separated from each other in a mounting base constituting the embodiment of the connector module according to the present disclosure.

FIG. 14 is a plan view illustrating the movement supporter coupled to the mounting base constituting the embodiment of the connector module according to the present disclosure.

FIG. 15 is a plan view illustrating the movement supporter and the door connector coupled to the mounting base constituting the embodiment of the connector module according to the present disclosure.

FIG. 16 is a plan view illustrating the movement supporter, the door connector, and a main connector connected to the mounting base constituting the embodiment of the connector module according to the present disclosure.

FIG. 17 is a plan view illustrating the movement supporter, the door connector, and the main connector moved upward from FIG. 3.

FIG. 18 is a perspective view illustrating a structure of the mounting base constituting the embodiment of the connector module according to the present disclosure.

FIG. 19 is a perspective view illustrating a structure of the movement supporter constituting the embodiment of the connector module according to the present disclosure.

FIG. 20 is a perspective view illustrating the door connector mounted to the movement supporter constituting the embodiment of the connector module according to the present disclosure.

FIG. 21 is a perspective view illustrating the structure of FIG. 20 at a different angle from FIG. 20.

FIG. 22 is a sectional view taken along line XXII-XXII′ of FIG. 17.

FIG. 23 is a sectional view illustrating the state of FIG. 22 without the door connector and the main connector.

FIG. 24 is a sectional view taken along line XXIV-XXIV′ of FIG. 17.

FIG. 25 is a perspective view illustrating the movement supporter and a connector assembly constituting the embodiment of the connector module according to the present disclosure, the movement supporter and the connector assembly being disposed at a storage position.

FIG. 26 is a perspective view illustrating the state of FIG. 25 at a different angle from FIG. 25.

FIG. 27 is a perspective view illustrating the movement supporter and the connector assembly constituting the embodiment of the connector module according to the present disclosure, the movement supporter and the connector assembly being disposed at an operation position.

FIG. 28 is a perspective view illustrating the state of FIG. 27 at a different angle from FIG. 27.

FIG. 29 is a perspective view illustrating a second embodiment of the door for a home appliance according to the present disclosure.

FIG. 30 is a perspective view illustrating the connector module constituting the third embodiment of the door for a home appliance according to the present disclosure.

FIG. 31 is a perspective view illustrating another embodiment of the home appliance according to the present disclosure.

### DETAILED DESCRIPTION

The present disclosure relates to one or more doors for an appliance, e.g., a home appliance. For example, the home appliance can include a storage space therein. The door can open and close the storage space. The door can be applied to various home appliances such as a cooking appliance, a refrigerator, a freezer, a kimchi refrigerator, a plant cultivating apparatus, Styler®, a washing machine, etc. In some examples, the door can be applied to a door of furniture or an entrance door. In some implementations, the door includes two doors 50 and 70, but the door of the present disclosure can also be applied to a home appliance equipped with a single lower door 70. Hereinafter, the present disclosure will describe an example in which two doors 50 and 70 are applied to a cooking appliance. Furthermore, a door at a relatively upper side of the two doors 50 and 70 can be called an upper door 50, and a door at a lower side can be called a lower door 70.

Herein, the front side may be a direction toward a user when the user is located in front of the home appliance. Referring to FIG. 1, an X-axial direction may be a forward direction. A Y-axial direction may be a width direction of a door 50, 70. A Z-axial direction may be a height direction of the door 50, 70. Hereinbelow, the present disclosure will be described based on the directions.

In some implementations, an electronic component can be disposed in the lower door 70 of the doors 50, 70. The electronic component can provide various functions to the lower door 70. For example, when the electronic component is an image acquisition module 100, the image acquisition module 100 can be used to obtain an inside image through a storage space. The lower door 70 can include the inner illuminance of the storage space. In some examples, the image acquisition module 100 can include an image sensing device 170 and a lighting device 180.

In some implementations, a display device can be disposed at the lower door 70 as an electronic component. The display device can provide the information of the home appliance to a user. The user can input an operational command through the display device.

The image acquisition module 100 or a part of the display device can be provided in the lower door 70. At this point, the electronic component such as the image acquisition module 100, the display device, or the like can receive and transmit an electric signal with a main controller provided in a main body of the home appliance, or can be connected to the main body with a wire to supply power.

At this point, a connector 270, 290 can be connected to the wire. The connector 270, 290 can include a door connector 270 disposed in the lower door 70 and a main connector disposed in the main body. The door connector 270 can be assembled with the main connector to be electrically connected thereto. On the other hand, the door connector 270 may not be assembled with the main connector, but an external connection connector. Herein, both the main connector and the connection connector will be called a relative connector 290.

Hereinbelow, it will be described that the electronic component disposed in the lower door 70 is the image acquisition module 100 as an example.

Referring to FIG. 1, the view illustrates a cooking appliance equipped with the doors 50 and 70. A main body 10 of the cooking appliance can be roughly shaped into a hexahedral form. In some examples, the main body 10 of the cooking appliance can include two doors 50 and 70. The two doors 50 and 70 can be disposed at different heights. The two doors 50 and 70 can serve to respectively shield different storage spaces.

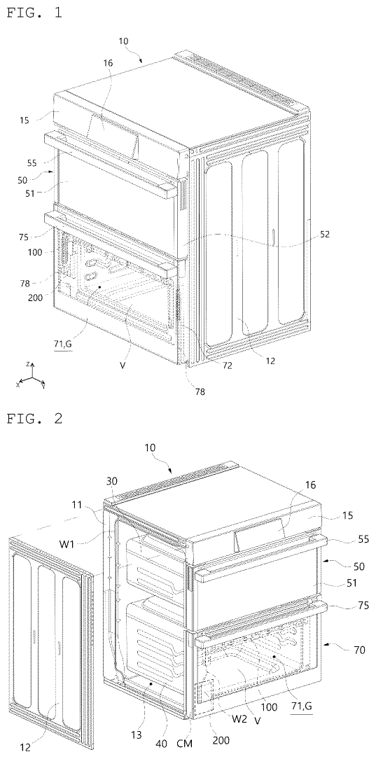

FIG. 2 illustrates a separated state of a side cover 12 constituting the main body 10 of the cooking appliance. When the side cover 12 is separated, an internal space 13 of the main body 10 of the cooking appliance can be exposed. Two cabinets 30 and 40 can be disposed inside the inside space 13 at different heights. The two cabinets 30 and 40 can include the storage spaces separated from each other. In some implementations, the inside space 13 can include one cabinet or three or more cabinets 30 and 40. In some implementations, the two cabinets 30 and 40 can be disposed transversely. Reference numeral 11 indicates a rear cover constituting the main body 10 of the cooking appliance.

An upper panel 15 can be provided at an upper portion of the cooking appliance. The upper panel 15 can be disposed on an upper end portion of a front surface of the cooking appliance. The upper panel 15 can include an operating part 16. The operating part 16 can be used to operate functions of the cooking appliance and display a state of the cooking appliance. The operating part 16 can be composed of a display capable of being operated in a touch manner. In some implementations, the operating part 16 can include a knob rotatably moved. In some implementations, the operating part 16 can be omitted, and the display device can be disposed at the lower door 70.

The upper panel 15 can be connected to a main wire W1. The main wire W1 can connect the operating part 16 and a main controller to each other. In some examples, the main wire W1 can connect the operating part 16 to the electronic component of the lower door 70, such as the image acquisition module 100. The main wire W1 can be connected to a connection wire W2 described below, through a door wire W2.

The two cabinets 30 and 40 can be classified into a first cabinet 30 and a second cabinet 40. The first cabinet 30 and the second cabinet 40 can be disposed in the inside space 13 at different heights. An upper storage space can be provided in a first cabinet 30. A lower storage space can be provided in the second cabinet 40. In some examples, the upper storage space and the lower storage space can be separated from each other, and can be open only at the front portions.

The upper door 50 can be disposed in front of the first cabinet 30. The lower door 70 can be disposed in front of the second cabinet 40. In some implementations, the upper door 50 and the lower door 70 can be operated in a kind of pull-down method in which each upper end is vertically swung on a lower end thereof. In some implementations, the upper door 50 and the lower door 70 can be operated in a side swing method in which each door is opened sideways.

In the upper door 50, a front surface 51 of the upper door 50 can have a structure allowing the upper storage space to be visible. For example, the front surface 51 of the upper door 50 has a glass panel structure, and a user can observe the inside part of the upper storage space through the upper door 50. In some examples, the front surface 51 of the upper door 50 can be made of dark materials or be coated with a separate film, thereby preventing the upper storage space from being visible from the outside. Reference numeral 55 indicates a first handle to open and close the upper door 50.

The lower door 70 can be disposed below the upper door 50. The lower door 70 can be disposed in front of the second cabinet 40. The lower storage space can be visible through a front surface of the lower door 70. The user can observe the inside of the lower storage space through the front surface of the lower door 70.

In some implementations, the lower door 70 can include a window V. The window V allows the lower storage space to be visible from the outside space and can be made of a transparent material. The window V can be understood as a part of a front panel Ga constituting the front surface of the lower door 70. The window V can be provided in a central portion of the front panel Ga. For example, an edge portion of the front panel Ga can have a material with higher surface roughness unlike the window V. Otherwise, a separate opaque film can be applied to the edge portion of the front panel Ga. Then, excluding the window V, the edge portion of the front panel Ga prevents the lower storage space form being visible.

In some implementations, the edge of the front panel Ga corresponding to the outside part of the window V can be covered by a door frame 72, 77, 80, 90. Herein, the outside part of the window V can be the edge portion of the front panel Ga that surrounds the edges of the window V with the window V as the center.

In some implementations, the lower door 70 can be made of dark materials or coated with a separate film, thereby preventing the lower storage space from being visible from the outside space. In some implementations, in the lower door 70, the door panel G which will be described below can be omitted, and an opaque metallic or nonmetallic plate can define the front surface thereof. Also, in this case, the lower storage space may not be visible from the outside space.

FIG. 2 illustrates the image acquisition module 100 and the connector module 200 which are mounted inside the lower door 70. Although FIG. 2 illustrates the image acquisition module 100 and the connector module 200 indicating positions where the image acquisition module 100 and the connector module 200 are mounted inside the lower door 70, the image acquisition module 100 and the connector module 200 may not be visible from the front space of the cooking appliance. This is because, as described above, the edge portion of the front panel Ga excluding the window Vis opaque. Reference numeral 75 indicates a second handle to open and close the lower door 70.

In some examples, the image acquisition module 100 can be disposed in the upper door 50. In some examples, two image acquisition modules 100 can be disposed in the upper door 50 and the lower door 70 respectively. In some examples, the image acquisition module 100 and the connector module 200 can be separately disposed in the upper door 50 and the lower door 70.

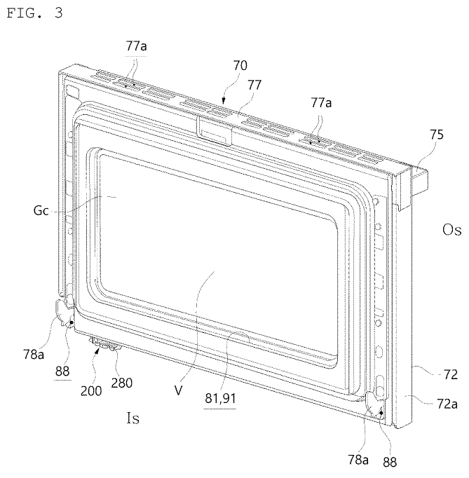

FIG. 3 illustrates the lower door 70 when viewed from the rear side. The front surface of the lower door 70 can have a flat surface structure. In some examples, the surface of the front panel Ga can define the front surface of the lower door 70.

The window V can be provided in the central portion of the front surface of the lower door 70. The window V can be a portion made of a transparent or translucent material so that the lower storage space can be visible from the outside space. The window V can be located through a central portion of a plurality of panels constituting the door panel G. FIG. 3 illustrates the window V provided in a central portion of a second rear panel Gc constituting the door panel G.

A frame of the lower door 70 can be formed from the door body. The door body can include the door frame 72, 77, 80, 90 and the door panel G. The door body can have roughly a hexahedral structure when the door frame 72, 77, 80, 90 and the door panel G are assembled.

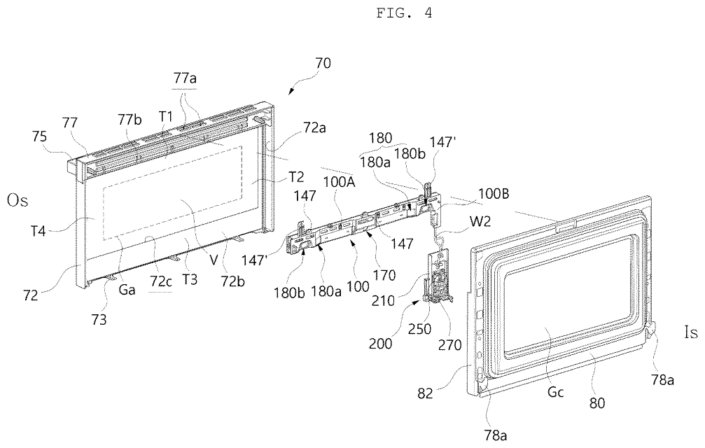

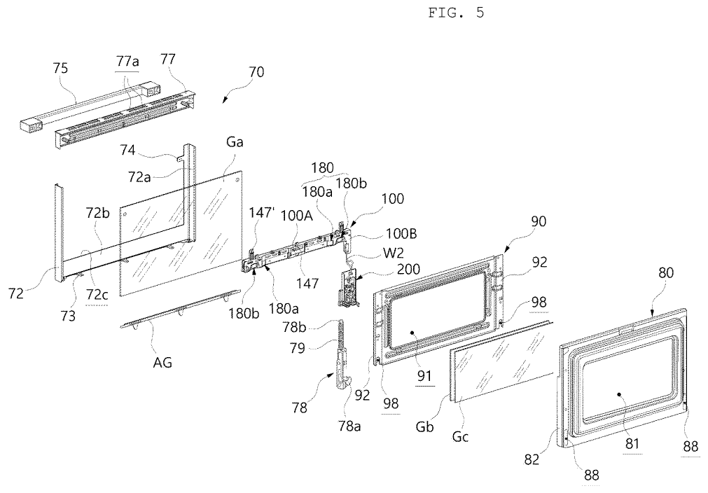

Referring to FIGS. 4 and 5, the door frame 72, 77, 80, 90 can include multiple frame parts. In some implementations, the door frame 72, 77, 80, 90 can include a front frame part 72, a rear frame part 80, an inner frame part 90, and the upper frame part 77. The frame parts can be coupled to each other to provide one door frame 72, 77, 80, 90.

Herein, “front” is based on the front side (X-axial direction in FIG. 1) of the lower door 70. For reference, in the entire drawings including FIG. 4, “Is” indicates the inside area of the lower door 70 facing the storage space, and “Os” indicates the outside area of the home appliance, i.e., the outside space of the lower door 70.

The front frame part 72 can be disposed at the front part of the door frame 72, 77, 80, 90. More specifically, the front frame part 72 can form a front frame of the door frame 72, 77, 80, 90. The front frame part 72 can be formed roughly in a rectangular frame shape. The front frame part 72 can be formed in a rectangular frame shape with an upper portion and a lower portion open upward and downward, respectively. A pair of front side plates 72a can be provided at both sides of the front frame part 72. The pair of front side plates 72a can stand vertically. A front lower plate 72b can connect the pair of front side plates 72a to each other while being located therebetween. The front side plates 72a and the front lower plate 72b are connected to each other to form roughly a “U” shape.

A front opening 72c can be provided between the front side plates 72a and the front lower plate 72b. The front opening 72c can be an empty space open in a longitudinal direction. The front panel Ga constituting the door panel G (referring to FIG. 1) can be disposed in the front opening 72c. It can be understood that an open portion of the front opening 72c is filled with the front panel Ga.

More specifically, the region of the door panel G is wider than the region of the front opening 72c, so a part of the front side plates 72a and a part of the front lower plate 72b can be stacked with the door panel G respectively. The front side plates 72a, the front lower plate 72b, and the front panel Ga can be coupled to each other by an adhesive or an adhesive tape. FIG. 4 illustrates the front panel Ga and the front frame part 72 stacked to each other. FIG. 4 illustrates the front panel Ga with a lower portion covering most of a rear surface of the front lower plate 72b.

With the second front side plates 72a of the front frame part 72 located in the center, the front panel Ga can be disposed at one side. The second handle 75 can be disposed at the opposite side of the second front side plates 72a. Herein, a separate fastener can pass through the second front side plates 72a and a panel fastening hole G2a′ of the front panel Ga and then can be fastened to a handle assembly part 75a of the second handle 75.

A lower frame part 73 can be provided at a lower end of the front frame part 72. The lower frame part 73 can be a part of the front frame part 72 or a separate object. The lower frame part 73 can have a shape bent from the lower end of the front frame part 72. The lower frame part 73 can include a connector inlet 73a. The connector inlet 73a can be provided at an operation position described below. A operator can access a connector storage portion CM through the connector inlet 73a.

The image acquisition module 100 can be disposed in rear of the front panel Ga. Herein, the image acquisition module 100 can be adhered to a rear surface of the front panel Ga. More specifically, a partial surface of a front surface of the image acquisition module 100 and a partial surface of the rear surface of the front panel Ga can be adhered to each other.

For reference, the image acquisition module 100 may include an image sensing device 170. The image acquisition module 100 may include a plurality of lighting devices 180 with the image sensing device 170. The plurality of lighting devices 180 increases the illuminance of the main storage space so that the image sensing device 170 acquires a clearer image. In the embodiment, the plurality of lighting devices 180 may include a first lighting part 180a and a second lighting part 180b. As another example, the image sensing device 170 or the plurality of lighting devices 180 may be omitted.

Referring to FIG. 5, a rear panel Gc of insulation panels Gb and Gc constituting a rear surface of the lower door 70 can be exposed rearward. The rear panel Gc can also include a window V. The window V of the rear panel Gc and the window V of the front panel Ga can be successively disposed at a predetermined distance therebetween and assigned with the same reference numeral. Although no reference numeral is assigned, in the insulation panels Gb and Gc, the inner panel Gb unexposed outward of the lower door 70 can also have a window V.

Describing the door panel G with reference to FIG. 5, the door panel G may include 3 panels in total. The 3 panels may include the front panel Ga disposed at the foremost side, the inner panel Gb disposed in the lower door 70, and the rear panel Gc disposed at the rearmost side. Among the panels, the front panel Ga may be exposed forward (a front side of the main body 10 of the home appliance, X-axial direction in FIG. 1). The rear panel Gc may be exposed rearward (a rear side facing the lower storage space) on the contrary to the front panel.

The inner panel Gb and the rear panel Gc can define the insulation panels Gb and Gc. The inner panel Gb and the rear panel Gc can be stacked to each other at a constant distance. In addition, an empty space between the inner panel Gb and the rear panel Gc can become a vacuum, thereby increasing insulation performance. In some implementations, the insulation panels Gb and Gc can include only the rear panel Gc without the inner panel Gb.

Installation regions T1 to T4 can be provided between the front panel Ga and the insulation panels Gb and Gc. The installation regions T1 to T4 can be provided in the empty space between the front panel Ga and the insulation panels Gb and Gc. The installation regions T1 to T4 can be a portion where the image acquisition module 100 and the connector module 200 are disposed. In some implementations, the insulation panels Gb and Gc are omitted, and the installation regions T1 to T4 can be disposed between the front panel Ga and the door frame 72, 77, 80, 90.

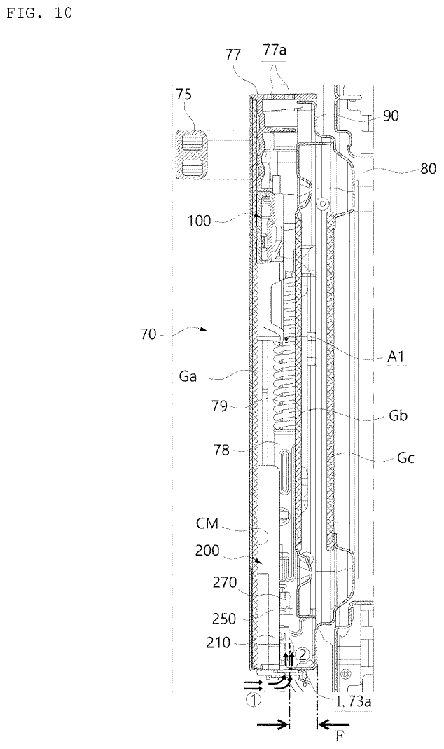

Referring to FIG. 10, a cooling flow path A1 can be provided between the front panel Ga and the insulation panels Gb and Gc. The cooling flow path A1 can be the entire space between the front panel Ga and the insulation panels Gb and Gc. The installation regions T1 to T4 can be disposed outside the window V with the window V as the center. Therefore, the cooling flow path A1 can be wider than the installation regions T1 to T4, and the installation regions T1 to T4 can constitute a part of the cooling flow path A1.

Air can flow into the door panel G along the cooling flow path A1. Accordingly, the cooling flow path A1 can be a flowing space in which air flows.

In some implementations, the door panel G is not provided as a separate object, but may be a part of the door frame 72, 77, 80, 90. The door panel G may be integrally provided with the door frame 72, 77, 80, 90. In this case, the door panel G is not made of a transparent material and may shield the main storage space to prevent the main storage space from being exposed. The door panel G may be made of the same material as the door body. For example, the door panel G may have a metal or nonmetal plate structure.

In FIG. 4, the installation regions T1 to T4 are indicated. The installation regions T1 to T4 are portions where the image acquisition module 100 and the connector module 200 are disposed, and a dotted line in FIG. 4 is expressed to help understand the installation regions T1 to T4. In FIG. 4, the installation regions T1 to T4 are illustrated at the rear surface of the front panel Ga, but the installation regions T1 to T4 are actually provided in the empty space between the plurality panels and the door frame 72, 77, 80, 90.

Herein, the upper frame part 77 of the door frame 72, 77, 80, 90 can cover a part of an upper end of the rear surface of the front panel Ga. A part of the installation regions T1 to T4 can be formed in a portion not covered by the upper frame part 77. More specifically, in the installation regions T1 to T4, the first installation region T1, T3 can be provided at a lower portion of the upper frame part 77 that is not covered by the upper frame part 77.

The installation regions T1 to T4 may include (i) the first installation region T1, T3 formed in a first direction along an edge of the window V, and (ii) a second installation region T2, T4 formed in a second direction different from the first direction along an edge of the window V. In the embodiment, the first direction is a transverse direction (a transverse width direction of the lower door 70, Y-axial direction in FIG. 1), and the second direction is a vertical direction (a height direction of the lower door 70, Z-axial direction in FIG. 1).

The first installation region T1, T3 can be formed at each of an upper portion T1 and a lower portion T3 of the window V with the window V as the center. The second installation region T2, T3 can be formed at each side portion of the window V with the window V as the center. In other divisions, the installation region T1 to T4 can be divided into (i) the upper region T1 provided at the upper portion of the window V, (ii) the right region T2 provided at the right portion of the window V, (iii) the lower region T3 provided at the lower portion of the window V, and (iv) the left region T4 provided at the left portion of the window V. The division is based on FIG. 4.

The first installation region T1, T3 and the second installation region T2, T3 can be connected to each other. Opposite end portions of the first installation region T1, T3 and the opposite end portions of the second installation region T2, T3 are connected to each other. Accordingly, the installation regions T1 to T4 can be formed in connected spaces. Then, the image acquisition module 100 and the connector module 200 can be disposed to pass through the multiple installation regions T1 to T4.

In some examples, a main unit 100A, i.e., a part of the image acquisition module 100 can be disposed in the first installation region T1, T3. A part of a connection unit 100B, i.e., a remaining part of the image acquisition module 100 can be disposed in the second installation region T2, T3. The image acquisition module 100 and the connector module 200 can be electrically connected to each other through the door wire W2. In some implementations, the connector module 200 is disposed in the second installation region T2, T3.

At least a part of the installation regions T1 to T4 can be provided at a region where a part of the door frame 72, 77, 80, 90 covers a rear surface of the front panel Ga. At this point, covering, by the rear frame part 80, a part of the image acquisition module 100 can be based on the rear space of the lower door 70, i.e., a direction from the inside space of the lower storage space to the rear surface of the lower door 70 when the lower door 70 is closed.

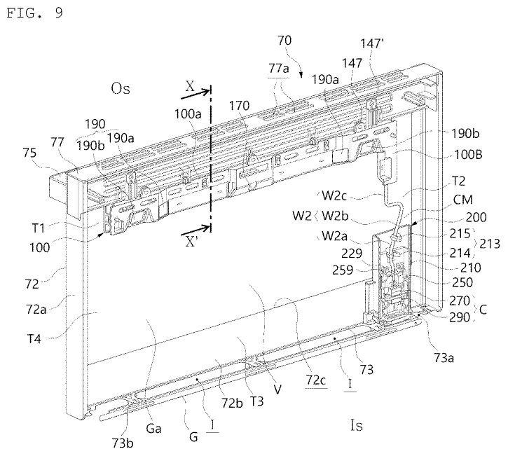

In some implementations, the connector module 200 can be disposed in a part of the second installation region T2, T3, and a part of the first installation region T1, T3. FIG. 9 illustrates the connector module 200 disposed over the right side region T2 provided at the right side portion of the window V, and the lower region T3 provided at a lower portion of the window V Both the right side region T2 and the lower region T3 are provided outside the window V, so the regions may not be exposed outward.

In some implementations, the connector module 200 can be disposed at one of the regions including the upper region T1, the lower region T3, and the left side region T4. In some examples, the connector module 200 does not extend to the lower region T3, and can be disposed in the right side region T2.

Preferably, considering the accessibility of the operator, one end portion of the connector module 200 can be disposed at an outer edge of the installation region T1 to T4. Then, the operator can easily access one end portion of the connector module 200 to assemble or maintain the connector module 200.

The image acquisition module 100 can be disposed in the first installation region T1, T3, and the door wire W2 for allowing signal transmission and power supply between the image acquisition module 100 and the main controller can be disposed in the second installation region T2, T3.

Herein, the front panel Ga can be divided into the window V, and an edge part disposed around the edges of the window V. Herein, the installation regions T1 to T4 can be provided on a rear surface of the edge part. At this point, the edge part can be processed to be opaque. Accordingly, the installation regions T1 to T4 provided at a lower surface of the edge part may not be exposed from the front space of the lower door 70, i.e., from the front space of the cooking appliance. The edge part can be formed by etching a part of the front panel Ga to increase the surface roughness, or by being coated with a separate film, or by being treated opaquely by a painting process.

In some implementations, the upper frame part 77 can be disposed above an upper portion of the front opening 72c. The upper frame part 77 can be coupled to an upper portion of the front frame part 72, more specifically, to the upper ends of the pair of front side plates 72a. The upper frame part 77 can cover a part of an upper end of the rear surface of the front panel Ga. The image acquisition module 100 described below can be fixed to the upper frame part 77. Reference numerals 147 and 147′ indicate module fastening parts to which fasteners are coupled to fix the image acquisition module 100 to the upper frame part 77.

The frame outlet 77a can be open in the upper frame part 77. The frame outlet 77a can be an outlet through which air passing through the cooling flow path A1 formed in the lower door 70 is discharged outward. The frame outlet 77a can be connected to the installation regions T1 to T4 as described below.

Referring to FIG. 5, the lower door 70 can include a door hinge 78. The door hinge 78 can allow the lower door 70 to be connected to the main body 10 of the cooking appliance to be turned. The door hinge 78 can be disposed in the lower door 70, more specifically, in an empty space formed between the front frame part 72 and an inner frame part 90. A door hinge arm 78a can protrude on the door hinge 78. The hinge holding arm 78a can pass through an inner hinge passage part 98 of the inner frame part 90 and a rear hinge passage part 88 of the rear frame part 80 in order, and then can be fixed by being caught by the main body 10 of the cooking appliance. Reference numeral 79 is a hinge spring 79 and can be fitted over a spring guide 78b of the door hinge 78. The hinge spring 79 can provide an elastic force to the door hinge 78 in a direction of closing the lower door 70 while being tensioned when the lower door 70 is opened.

With the door panel G located in the middle, the front frame part 72 can be disposed at the front of the door panel G, and the inner frame part 90 and the rear frame part 80 can be disposed at the rear of the door panel G. The inner frame part 90 and the rear frame part 80 are spaced apart from each other (i) to form an insulation space therebetween, and (ii) to fix the second insulation panels Gb and Gc. The inner frame part 90 can be disposed between the rear frame part 80 and the front frame part 72, thereby being unexposed outward.

The rear frame part 80 may be roughly formed in a rectangular frame shape. When the lower door 70 is closed, the rear frame part 80 may face a front surface of the second cavity. The rear through part 81 may be open on a central portion of the rear frame part 80. The rear through part 81 may have a longitudinally open structure so that the internal space of the main storage space may be visible through the window V.

Rear side plates 82 can be provided at side surfaces of the rear frame part 80. The rear side plates 82 can be bent forward of the lower door 70. The rear side plates 82 can be disposed inside the front side plates 72a. Reference numeral 88 is the rear hinge passage part 88 through which the door hinge arm 78a of the door hinge 78 passes.

The rear frame part 80 can cover a part of the connector module 200. Accordingly, even when the user opens the lower door 70, the connector module 200 may not be exposed through the window V.

The inner frame part 90 may be coupled to the rear frame part 80. The inner frame part 90 may be formed roughly in a rectangular frame shape. When the lower door 70 is closed, the inner frame part 90 may stand vertically at a distance from the rear frame part 80. An inner through part 91 may be open on a central portion of the inner frame part 90. The inner through part 91 may have a longitudinally open structure so that the internal space of the main storage space may be visible through the window V.

Inner side plates 92 can be provided at side surfaces of the inner frame part 90. The inner side plates 92 can be bent forward of the lower door 70. The inner side plates 92 can overlap with the rear side plates 82. At the overlapped portions, the inner side plates 92 and the rear side plates 82 can be coupled to each other in a method such as welding, adhesion, or fastening by a separate fastener.

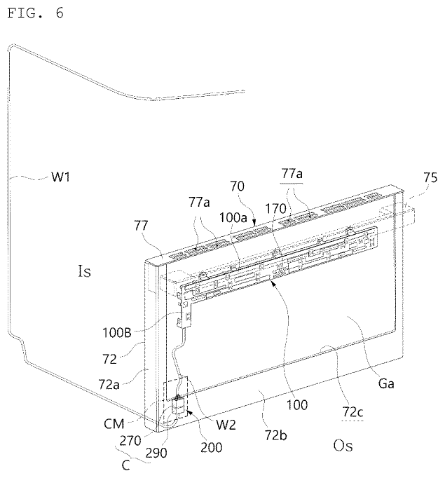

FIG. 6 illustrates the lower door 70 when viewed from the front space of the lower door 70. A wire to achieve power supply or signal transmission can be disposed in the main body 10 and the lower door 70 of the home appliance. The wire can include the main wire W1 to connect the connector module 200 of the lower door 70 to the main controller in the main body 10, and the door wire W2 to connect the connector module 200 to the image acquisition module 100.

When necessary, the operator can separate the main wire W1 from the connector module 200, and perform maintenance/repairing to the image acquisition module 100. For reference, FIG. 6 is a perspective view illustrating the image acquisition module 100. However, the image acquisition module 100 can be shielded by the edge part of the front panel Ga. FIG. 6 illustrates the door connector 270 constituting the connector module 200 assembled to the relative connector 290.

The connector module 200 can be disposed in the installation region T1 to T4 of the lower door 70. More specifically, the connector storage portion CM can be provided in the installation region T1 to T4. The connector module 200 can be disposed in the connector storage portion CM. The connector storage portion CM can be an empty space, i.e., a part of the installation region T1 to T4. In some implementations, the connector storage portion CM can be a kind of bracket integrated with the installation region T1 to T4, or provided as a separate object.

In FIG. 6, the connector storage portion CM can be disposed close to a lower end portion of a side surface of the lower door 70. When the connector storage portion CM is disposed at the lower end portion of the lower door 70, the operator can access the connector module 200 through the lower portion of the lower door 70. When the connector storage portion CM is disposed at the lower end portion of the lower door 70, the connector module 200 can be prevented from being exposed outward normally. Furthermore, as described below, the connector inlet 73a of the connector storage portion CM can open through the lower end portion of the lower door 70, so the operator can easily access the connector module 200.

In some implementations, the connector storage portion CM can be disposed close to an upper end portion of a side surface of the lower door 70. Furthermore, the connector inlet 73a of the connector storage portion CM can be open through the side surface of the lower door 70.

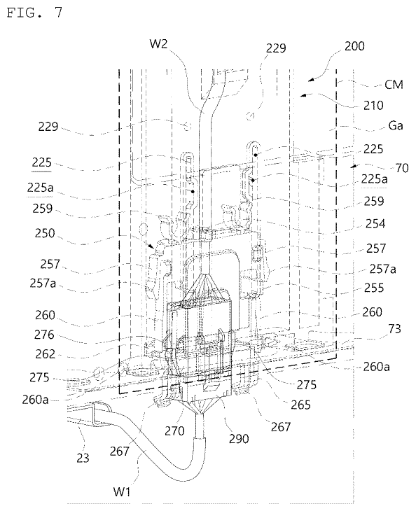

FIG. 7 illustrates the connector module 200 disposed in the connector storage portion CM. Herein, the view illustrates the relative connector 290 separated from the door connector 270 of the connector module 200. The door connector 270 can be disposed at a lower end portion of the connector storage portion CM. Accordingly, the relative connector 290 can be easily assembled to and separated from the door connector 270.

As illustrated in FIG. 7, the connector storage portion CM can be disposed outside the window V. Accordingly, the connector storage portion CM and the connector module 200 disposed in the connector storage portion CM may not be exposed outward, or the exposed region can be minimized.

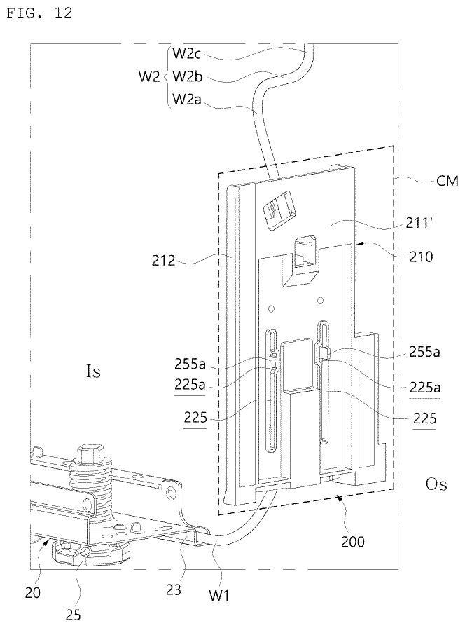

In FIG. 12, reference numeral 20 indicates a side frame 20 supporting a lower end of the main body 10. The side frame 20 can include a wire tube 23 guiding a mounting direction of the main wire W1. The main wire W1 can be disposed at a side surface of a lower portion of the main body 10 along the wire tube 23. Reference numeral 25 is a support leg to adjust the height of the main body 10.

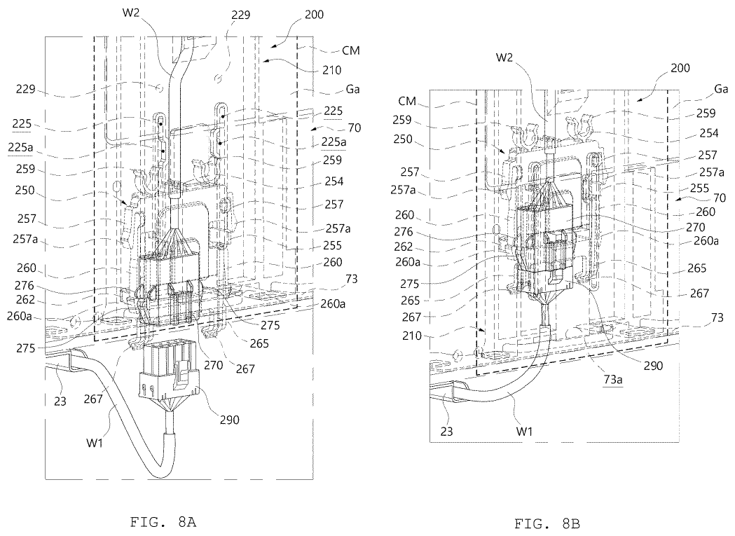

FIGS. 8A and 8B illustrate a process in which the door connector 270 disposed in the connector storage portion CM is assembled with the relative connector 290. First, the door connector 270 can be moved to the operation position in the connector storage portion CM. FIG. 8A illustrates the door connector 270 disposed at the operation position. Then, the relative connector 290 can be assembled to the door connector 270.

Herein, the door connector 270 can be fixed to the operation position as described below, so the operator can prevent from separately gripping the door connector 270 when the operator assembles the relative connector 290 to the door connector 270. When the assembly of the door connector 270 and the relative connector 290 (hereinbelow, which will be referred to as a connector assembly C) are inserted into the connector storage portion CM (upper side based on FIG. 7), the connector assembly C can be moved to the storage position. This state is illustrated in FIG. 8B.

For reference, the storage position is a position where the connector assembly C is moved to the inside part of the connector storage portion CM not to be exposed outward. Furthermore, the operation position is a position where the door connector 270 is moved to the connector inlet 73a of the connector storage portion CM to be assembled to/separated from the relative connector 290 and the assembly surface 271a of the door connector 270 is exposed outward. Herein, the storage position can be a first position, and the operation position can be a second position.

FIG. 9 illustrates the rear surface of the lower door 70. As illustrated in the drawing, the connector module 200 can be disposed in the lower portion of the side surface of the lower door 70. One end of the connector module 200 can be disposed in the lower end portion of the lower door 70. The connector module 200 can be disposed vertically, i.e., in the height direction of the lower door 70.

The lower frame part 73 can be provided at the lower end of the lower door 70. The connector inlet 73a of the connector storage portion CM can be open in the lower frame part 73. As illustrated in FIG. 9, the connector inlet 73a can be formed by vertically penetrating the lower frame part 73. The connector inlet 73a can be a part of air inlets I, i.e., a plurality of inlets of the cooling flow path A1 which are open in the lower frame part 73. Reference numeral 73b indicates a bracket provided in the lower frame part 73 to mount the air guide G. Furthermore, reference numeral 190 is a lighting cover to cover each lighting device 180.

The connector module 200 can include the door connector 270. The door connector 270 can be connected to a first end portion of the door wire W2. The first end portion of the door wire W2 can be coupled to the door connector 270, and a second end portion can be connected to the image acquisition module 100. FIG. 6 illustrates the second end portion of the door wire W2 connected to the image sensing device 170 of the image acquisition module 100. In some examples, the second end portion of the door wire W2 can be connected to each lighting device 180. In some examples, the second end portion of the door wire W2 can be connected to another electronic component such as the display device, etc.

The door connector 270 can be disposed in the connector storage portion CM. The door connector 270 can be moved between the first position and the second position in the connector storage portion CM. The first position can be the storage position. The second position can be the operation position. For reference, FIG. 9 illustrates the door connector 270 disposed at the storage position.

In some examples, the door connector 270 can be mounted to a movement supporter 250 and moved with the movement supporter 250. The movement supporter 250 can be mounted to the connector storage portion CM. Herein, the movement supporter 250 can be moved along a mounting base 210 disposed in the connector storage portion CM. In some examples, the movement supporter 250 can be omitted, and the door connector 270 can be directly disposed in the mounting base 210. The structures of the movement supporter 250 and the mounting base 210 will be described below.

FIG. 10 illustrates the connector storage portion CM provided at the lower portion of the lower door 70. The connector storage portion CM can be provided around a lower inlet of the cooling flow path A1. The door connector 270 can be disposed in the connector storage portion CM. To move the door connector 270, there is a need to access the connector storage portion CM. In some examples, the connector inlet 73a can be open in the lower portion of the lower door 70.

Herein, the width of the connector inlet 73a can be larger than the thickness of the door connector 270. Herein, the width of the connector inlet 73a can be based on the transverse direction of the lower door 70 and can be the transverse width based on FIG. 10. The thickness of the door connector 270 can be based on the longitudinal direction of the lower door 70. When the width of the connector inlet 73a is larger than the thickness of the door connector 270, the connector inlet 73a can have a clearance. The clearance can be an operation space F. FIG. 10 illustrates the width of the operation space F. The operator can access the door connector 270 through the operation space F.

The operation space F can be formed between a surface of the door connector 270 and an edge of the connector inlet 73a. The operation space F can be an empty space between the surface of the door connector 270 and the inner frame part 90. The operation space F can be a space through which the operator can access the door connector 270 and an air inlet through which external air is introduced into the lower door 70 at the same time.

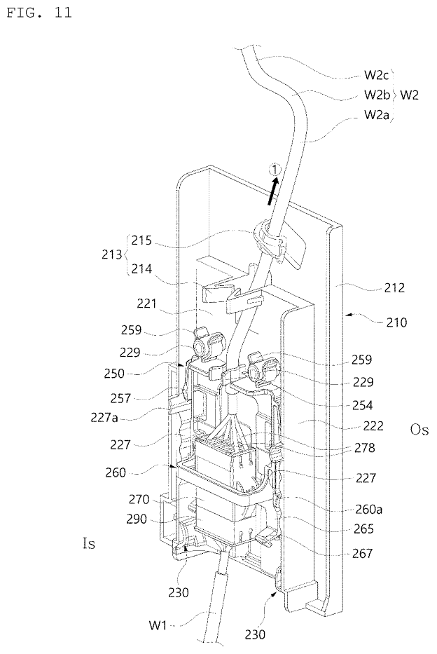

FIG. 11 illustrates an example of the connector module 200. The connector module 200 can be disposed between the main wire W1 and the door wire W2. More specifically, the relative connector 290 to which the main wire W1 is connected can be connected to the door connector 270 to which the door wire W2 is connected, in the connector module 200. FIG. 11 illustrates the door wire W2 and the main wire W1 electrically connected to each other with the door connector 270 and the relative connector 290 assembled.

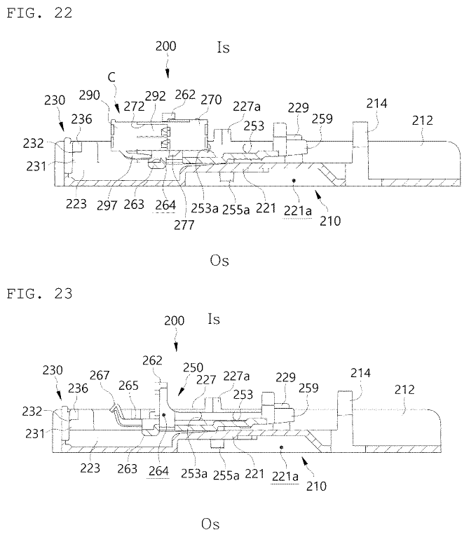

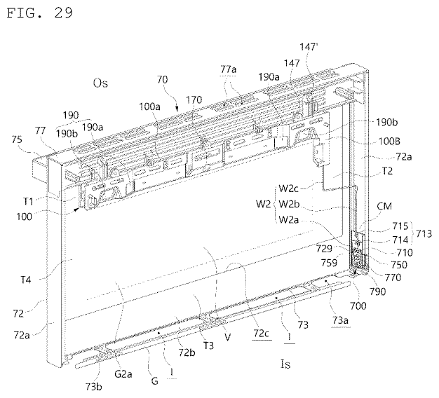

For convenience of description, describing the door connector 270 of the connector module 200 with reference to FIG. 20, the door connector 270 can have roughly a hexahedral structure. The door connector 270 can include a connector body 271 of an insulator in which a plurality of terminals can be disposed. Terminal wires 278 can be connected to the terminals. The terminal wires 278 can constitute the door wire W2. FIGS. 22 and 29 illustrate terminal holes 272 into which the terminals are inserted.

An assembly surface 271a can be provided on a front surface of the door connector 270. The assembly surface 271a can be a surface facing the connector inlet 73a. The assembly surface 271a can be a portion assembled with the relative connector 290.

A structure can be disposed on the surface of the door connector 270 to fix the door connector 270 to the movement supporter 250. Specifically, a connector lance part 275 can protrude on a surface of the door connector 270. The connector lance part 275 can pass through a mounting hole 264 provided in the movement supporter 250 and can be fixed by being caught by the opposite side of the mounting hole 264. Then, the door connector 270 is prevented from being separated in the opposite direction, i.e., an upward direction based on FIG. 20.

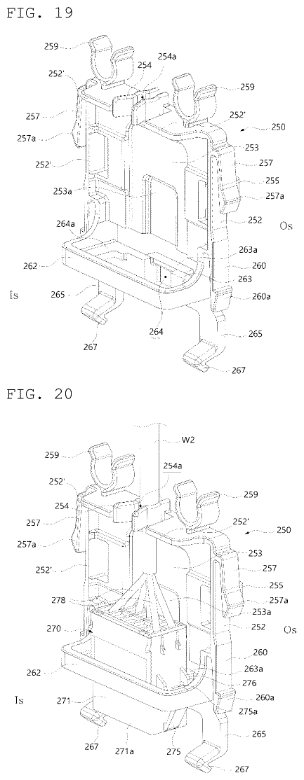

A connector protrusion 276 can be provided on a surface of the door connector 270. The connector protrusion 276 can fix the door connector 270 to the movement supporter 250. The connector protrusion 276 can be caught by a holding end portion 264a (referring to FIG. 19) provided at an edge of the mounting hole 264. When the connector protrusion 276 is caught by the holding end portion 264a, the door connector 270 is no longer moved in the mounting direction, i.e., in a downward direction based on FIG. 20. Eventually, the door connector 270 can be fixed in the opposite directions.

The connector module 200 can include the mounting base 210. The mounting base 210 can be fixed to the connector storage portion CM. The mounting base 210 can guide the movement of the movement supporter 250 and the movement of the door connector 270. Since the mounting base 210 can be fixed, the mounting base 210 can be moved relatively to the movement supporter 250 and the door connector 270. FIG. 11 illustrates the door connector 270 disposed at the storage position.

The mounting base 210 can guide the movement of the movement supporter 250 and the movement of the door connector 270. The mounting base 210 can be fixed to the connector storage portion CM, thereby preventing the movement supporter 250 and the door connector 270 from also being separated from the connector storage portion CM. The mounting base 210 can guide an extension direction of the door wire W2 as described below.

Describing the mounting direction of the mounting base 210, as illustrated in FIG. 12, a rear surface of the mounting base 210 may face the front space (X-axial direction in FIG. 1) of the lower door 70. When viewed from the front space of the lower door 70, the movement supporter 250 and the door connector 270 disposed on the front surface of the mounting base 210 may be covered by the mounting base 210. Of course, since the connector module 200 including the mounting base 210 is disposed outside the window V, the connector module 200 may be covered by an edge portion of the lower door 70.

In some examples, the mounting base 210 can cross a portion of the window V, but a lower surface of the mounting base 210 has a flat surface structure, and the mounting base 210 can cover both the door connector 270 and the movement supporter 250, so the mounting base 210 can be partially exposed to external space (front space of the lower door 70.

The door wire W2 can extend upward of the mounting base 210. The main wire W1 can extend downward of the mounting base 210. The mounting base 210 can be disposed closer to the wire tube 23 provided in the side frame 20, so an exposure area of the main wire W1 can be reduced.

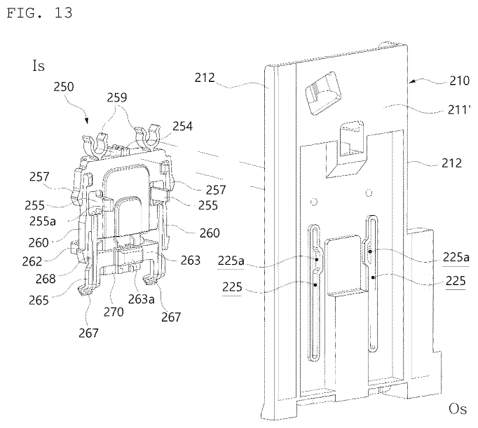

Referring to FIG. 13, the movement supporter 250 and the door connector 270 can be separated from the mounting base 210. When the movement supporter 250 is mounted to the mounting base 210, the movement supporter 250 can be linearly moved along the mounting base 210. The movement supporter 250 can be separated from the mounting base 210 or assembled with the mounting base 210 only at a specific position. This structure will be described below.

FIG. 14 illustrates the movement supporter 250 mounted to the mounting base 210. For reference, FIG. 14 illustrates the movement supporter 250 in the operation position. As illustrated in the drawing, a vertical height of the mounting base 210 in a movement direction of the movement supporter 250 can be formed wider than a transverse width perpendicular to the vertical height. The transverse width of the mounting base 210 can be formed smaller than or equal to the width of the installation region T1 to T4. Accordingly, the mounting base 210 may not be separated from the installation region T1 to T4.

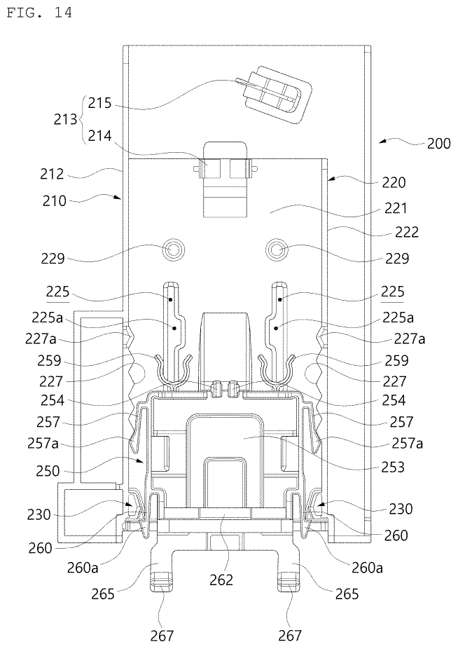

FIG. 15 illustrates the assembly of the movement supporter 250 and the door connector 270, the assembly being mounted to the mounting base 210. FIG. 15 illustrates the structure of the connector module 200 based on a direction from the inside part of the storage space toward the lower door 70. As described above, the mounting base 210 does not completely cover the movement supporter 250 and the door connector 270, but can expose the movement supporter 250 and the door connector 270. In some implementations, the connector module 200 can be disposed in the connector storage portion CM provided in the door, thereby being prevented from being visible from the outside space.

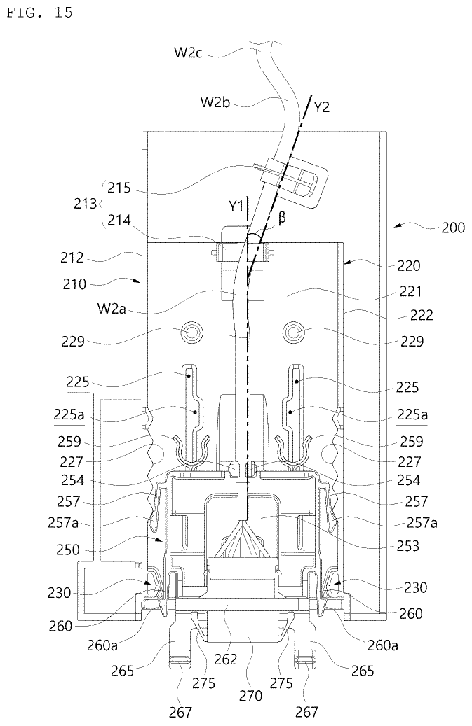

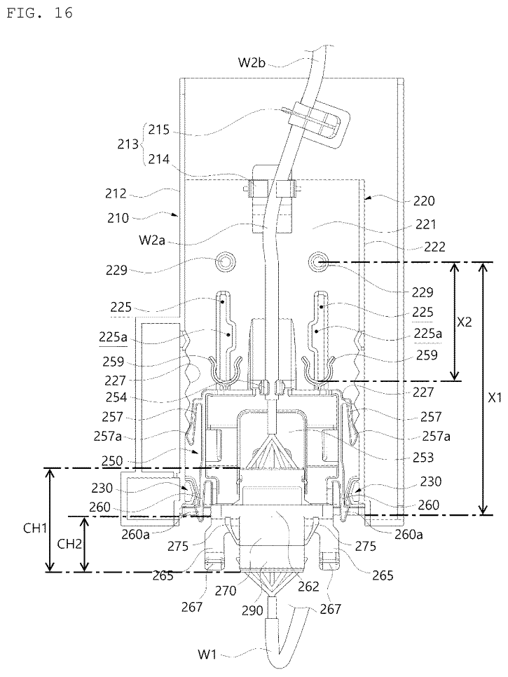

FIG. 16 illustrates the connector module 200 illustrated in FIG. 15 with the relative connector 290 assembled. In FIG. 16, the door connector 270 and the relative connector 290 are in the operation position. In the operation position, the door connector 270 can be assembled with or separated from the relative connector 290. When the relative connector 290 is pushed upward from the state illustrated in FIG. 16, the door connector 270 and the movement supporter 250 can be moved with the relative connector 290. Then, the door connector 270, the relative connector 290, and the movement supporter 250 can be moved to the storage position.

Herein, the door connector 270 can be moved in a constant section with the movement supporter 250. As described below, a mounting stopper 229 provided in the mounting base 210 can interfere with a stopping holder 259 of the movement supporter 250 to limit a movement range of the movement supporter 250. More specifically, the mounting stopper 229 can limit the depths at which the movement supporter 250 and the door connector 270 are inserted.

The mounting base 210 can include a restraint maintaining part 230 provided at the opposite side of the mounting stopper 229. When the movement supporter 250 and the door connector 270 are moved to the operation position, the restraint maintaining part 230 can enable the movement supporter 250 and the door connector 270 to be fixed without being separated from the operation position. A detailed structure of the restraint maintaining part 230 will be described below again.

As illustrated in FIG. 16, a part of the door connector 270 disposed in the operation position can protrude outside the connector inlet 73a. In the drawing, CH1 indicates the entire length of the connector assembly C. The sum of the length of a part of the door connector 270 protruding outside the connector inlet 73a and the length of the relative connector 290 is indicated as CH2.

Herein, the sum CH1 of the length of the door connector 270 and the length of the relative connector 290 can be smaller than or equal to a distance X1 from a lower end of the mounting base 210, i.e. the operation position, to the mounting stopper 229. Accordingly, the entire connector assembly C can be completely seated on the mounting station 220. The distance X1 from the lower end of the mounting base 210 to the mounting stopper 229 can be longer than the length of the movement supporter 250.

The sum CH2 of the length of the part of the door connector 270 protruding outward of the connector inlet 73a and the length of the relative connector 290 can be shorter than or equal to a movement range X2 of the door connector 270. Then, when the connector assembly C is moved to the storage position, the relative connector 290 can also be moved to the storage position to prevent the entire connector assembly C from being exposed outward. In other words, when the connector assembly C is moved to the storage position, the relative connector 290 can also be moved to the storage position so that the entire connector assembly C can be disposed above the lower end of the mounting base 210.

FIG. 17 illustrates the connector assembly C and the movement supporter 250 in the storage position. As illustrated in the drawing, a lower end of the relative connector 290 can be disposed above the lower end of the mounting base 210. Therefore, the relative connector 290 can be prevented from protruding outward of the connector inlet 73a. On the other hand, the movement supporter 250 is no longer moved in the upward direction based on FIG. 17, due to interference with the mounting stopper 229.

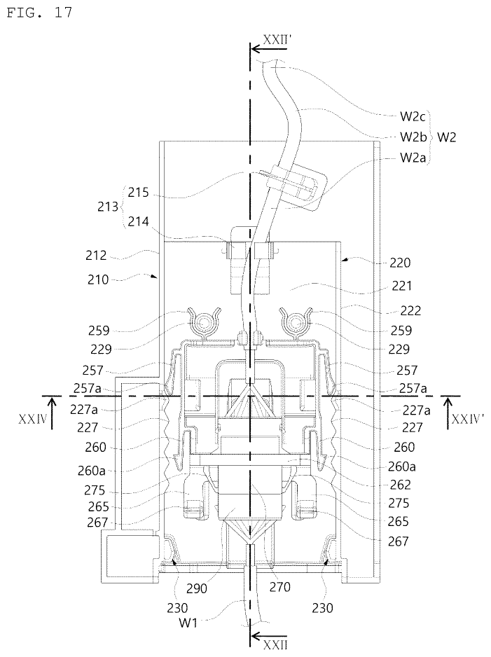

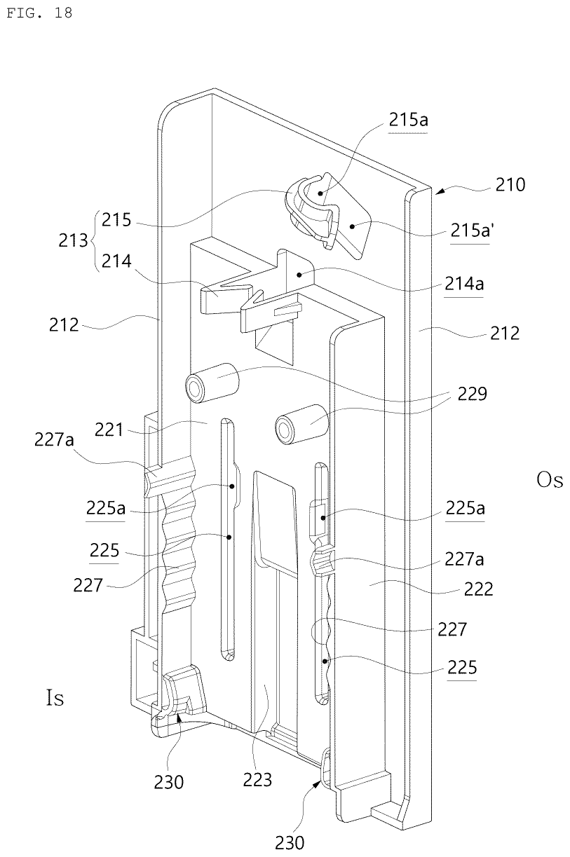

The structure of the mounting base 210 will be described in detail with reference to FIG. 18. A frame of the mounting base 210 may be formed of a base body 211 of a flat plate structure. The mounting station 220 may be disposed on a first surface of the base body 211. A second surface 211′ of the base body 211 (referring to FIG. 13) may be brought into close contact with a surface of the front panel Ga. For example, the second surface 211′ of the base body 211 may adhere to the surface of the front panel Ga as a fixation surface. As another example, the base body 211 may be fixed to the door frame 72, 77, 80, 90, not a surface of the front panel Ga.

A guide fence 212 can be provided at either side of the base body 211. The guide fence 212 can stand outside the mounting station 220. The guide fence 212 can be provided in a movement direction of the door connector 270 outside the mounting station 220. In some examples, the guide fence 212 can be provided at either side of the mounting station 220. In some examples, the guide fence 212 can be provided only on either side of the mounting station 220 or can be omitted.

The guide fence 212 can form a movement path of the movement supporter 250 and the door connector 270 with an inner fence 222 described below. The guide fence 212 and the inner fence 222 can guide the movement of the movement supporter 250 and the door connector 270. The inner fence 222 can be adjacent to the mounting station 220 and provided along a side surface of the mounting station 220. The inner fence 222 can be a part of the guide fence 212.

The base body 211 can include a wire guide 213. The wire guide 213 can guide a direction in which the door wire W2 extends. The wire guide 213 can protrude from the base body 211. The wire guide 213 can be disposed between the image acquisition module 100 and the door connector 270. The wire guide 213 covers the door wire W2 so that the door wire W2 extends in a preset direction. In some examples, since the door connector 270 is moved, a relative distance between the door connector 270 and the fixed wire guide 213 can change.

The base body 211 can include a plurality of wire guides 213. The plurality of wire guides 213 can be provided in an extension direction of the door wire W2. In some examples, the plurality of wire guides 213 can include a first guide 214 and a second guide 215.

The first guide 214 can be disposed at an edge of the mounting station 220. The second guide 215 can deviate from the mounting station 220 and be disposed outside the mounting station 220. The door wire W2 can extend toward the image acquisition module 100 while passing through the first guide 214 and the second guide 215 in order.

The first guide 214 and the second guide 215 can be disposed to be offset from each other based on the movement direction of the door connector 270. The first guide 214 can be disposed on a position passing through a central portion of the door connector 270. The second guide 215 can be provided on a position deviating from the center of the door connector 270 and biasing to a side surface of the base body 211, more specifically, to an edge of the door body. The first guide 214 and the second guide 215 can be disposed to be transversely spaced apart from each other based on a transverse width direction of the door body. Accordingly, the second guide 215 can guide the extension direction of the door wire W2 in a direction far away from the window.

As another example, the wire guide 213 may include one of the first guide 214 or the second guide 215.

The first guide 214 can have a structure of a pair of facing cantilevers. A first guide hole 214a surrounding the door wire W2 can be formed between the pair of cantilevers. In some examples, the first guide 214 can have a single hook structure. In some examples, the first guide 214 can be integrated with the base body 211. In some examples, the first guide 214 can be formed into a separate object from the base body 211 and then fixed to the base body 211.

The second guide 215 can protrude roughly into a “U” shape. A second guide hole 215a surrounding the door wire W2 can be formed in the second guide 215. In some examples, the second guide 215 can have a structure of a pair of cantilevers like the first guide 214. In some examples, the second guide 215 can be integrated with the base body 211. In some examples, the second guide 215 can be formed into a separate object from the base body 211 and then fixed to the base body 211. The structure of the wire guide 213 will be described again with a wire fixation part 254 described below.

Herein, a wire insertion port (215a′) into which the door wire W2 is inserted can be provided at one side portion of the second guide 215. The wire insertion port can be open in a direction toward the edge of the door body. Accordingly, the door wire W2 inserted into the wire insertion port can be separated only in the edge direction of the door body, and not be separated in a direction toward the window V.

The first guide hole 214a and the second guide hole 215a can be open in different directions. The first guide hole 214a can be open in the movement direction of the movement supporter 250. The second guide hole 215a can be open in a direction different from the movement direction of the movement supporter 250. In some examples, the second guide hole 215a can be open in a direction biasing toward the edge of the door body.

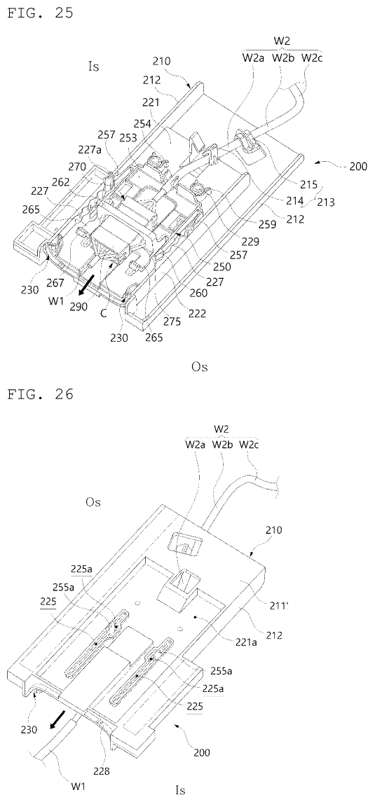

The first guide hole 214a and the second guide hole 215a may have different heights. Referring to FIG. 18, the height of the first guide hole 214a is formed higher than the height of the second guide hole 215a. When the height of first guide hole 214a is higher than the height of the second guide hole 215a, a first portion W2a (referring to FIG. 25) of the door wire W2 where largest external force is applied in the movement process of the door connector 270 may be prevented from being excessively twisted.

Meanwhile, the connection unit 100B may include a connection hole (not illustrated) open toward the connector module 200. The door wire W2 may extend from the wire guide 213 toward the connection hole. The door wire W2 is guided by the wire guide 213, and may face the connection unit 100B rather than moving toward the window or a side surface of the door body which is the opposite thereto.

A seating surface 221 can be formed on a surface of the mounting station 220. The seating surface 221 can be a surface on which the movement supporter 250 slides on the surface of the mounting station 220. Since the mounting station 220 is a protruding portion of the base body 211, the seating surface 221 can be formed higher than other portions of the base body 211.

The seating surface 221 can include a supporter guide groove 223. The supporter guide groove 223 can be recessed from the seating surface 221. The supporter guide groove 223 can guide sliding of the movement supporter 250. A guide block 253a of the movement supporter 250 (referring to FIG. 22) can be inserted into the supporter guide groove 223 and the guide block 253a will be described below. While the guide block 253a is inserted into the supporter guide groove 223, the movement supporter 250 can be moved. Therefore, the supporter guide groove 223 can guide the movement of the movement supporter 250 in a constant direction. In some examples, the supporter guide groove 223 can be omitted.

The seating surface 221 can include a guide slot 225. The guide slot 225 can be formed longitudinally through the seating surface 221. The guide slot 225 can be provided at either side of the supporter guide groove 223 with the supporter guide groove 223 as the center. A guide arm 255 of the movement supporter 250 can be inserted into each guide slot 225, and the guide arm 255 will be described below. While the guide arm 255 is inserted into the guide slot 225, the movement supporter 250 can slide on the seating surface 221. Therefore, the guide arm 255 can guide the movement of the movement supporter 250 in a constant direction with the supporter guide groove 223. In some examples, one guide slot 225 and one guide arm 255 can be provided.

Herein, a direction in which the guide arm 255 is inserted into the guide slot 225 can be a first direction. A direction in which the guide arm 255 guides the movement of the movement supporter 250 with the supporter guide groove 223 can be a second direction. Herein, the first direction and the second direction can be different from each other. For example, the first direction and the second direction can be perpendicular to each other. In some examples, the first direction can oppose the second direction.

The guide slot 225 can include a slot entrance 225a. The slot entrance 225a can be a portion where the width of the guide slot 225 is widened. A guide head 255a of the guide arm 255 can be inserted into the slot entrance 225a. The guide head 255a can have a thicker portion than other portions of the guide arm 255. Therefore, after the guide head 255a is inserted into the slot entrance 225a, when the movement supporter 250 is moved from the slot entrance 225a, the guide head 255a can be caught by the guide slot 225 not to be separated.

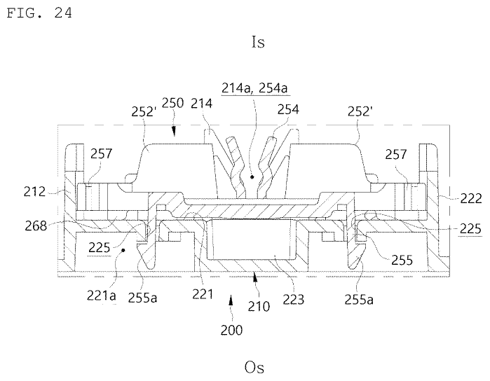

Referring to FIGS. 24 and 36, the guide head 255a and an edge of the guide slot 225 are spaced apart from each other, so a spacing can be provided therebetween. The spacing can prevent the guide head 255a from interfering with the edge of the guide slot 225 when the entire movement supporter 250 is turned. The movement supporter 250 can be relatively turned in a direction of reducing the spacing with respect to the mounting base 210.

A first position fixation portion 227 can be provided at either side of the seating surface 221. The first position fixation portion 227 can constitute a storage fixation portion 227, 257 with a second position fixation portion 257 described below. The first position fixation portion 227 can interfere with the movement supporter 250 to fix the movement supporter 250 and the connector assembly C to the storage position. When the movement supporter 250 and the connector assembly C are fixed to the storage position by the storage fixation portion 227, 257, the movement supporter 250 and the connector assembly C are not returned to the operation position, and can remain fixed to the connector storage portion CM.

The storage fixation portion 227, 257 can be continuously or discontinuously disposed in the movement direction of the door connector 270. When the storage fixation portion 227, 257 is continuously provided in the movement direction of the door connector 270, the movement supporter 250 and the connector assembly C can be fixed to a plurality of storage positions in phases. When the storage fixation portion 227, 257 is discontinuously provided in the movement direction of the door connector 270, the movement supporter 250 and the connector assembly C can be fixed to a limited specific storage position.

The storage fixation portion 227, 257 can include the first position fixation portion 227 and the second position fixation portion 257. The first position fixation portion 227 can be provided in the mounting base 210 of the connector module 200. The second position fixation portion 257 can be provided in the movement supporter 250 or the door connector 270. The second position fixation portion 257 can be engaged with the first position fixation portion 227. When the second position fixation portion 257 is engaged with the first position fixation portion 227, the second position fixation portion 257 can remain caught by and fixed to the first position fixation portion 227.

Referring to FIG. 17, the first position fixation portion 227 can be continuously provided along the guide fence 212. The first position fixation portion 227 can have an uneven structure. The first position fixation portion 227 can be configured by repeatedly arranging a structure protruding in a central direction of the seating surface 221, i.e., a central direction of the movement supporter 250, and a structure recessed in the opposite direction. For example, the first position fixation portion 227 can have a sawtooth structure. The first position fixation portion 227 of the sawtooth structure can form a kind of multistep structure. The second position fixation portion 257 can be fixed to a portion of a plurality of positions of the first position fixation portion 227 of the multistep structure. Accordingly, the movement supporter 250 can have a plurality of storage positions. In other words, in some examples, the storage fixation portion 227, 257 can have a kind of a free stop structure.

The storage fixation portion 227, 257 can include a pair of first position fixation portions 227. The pair of first position fixation portions 227 can be disposed to face each other. The pair of first position fixation portions 227 can be engaged with a pair of second position fixation portions 257 provided in the movement supporter 250.

Referring to FIG. 18, each first position fixation portion 227 can include a storage locking end 227a. The storage locking end 227a can be disposed at the innermost portion in the storage position. In some examples, based on the drawing, the storage locking end 227a can be disposed at the uppermost end of the first position fixation portion 227. When the second position fixation portion 257 is caught by the storage locking end 227a, the movement supporter 250 and the connector assembly C can be stored in the deepest position in the connector storage portion CM. This figure as described above is illustrated in FIG. 17.

The storage locking end 227a can further protrude than other portions of the first position fixation portion 227. When a protruding length of the storage locking end 227a is relatively longer than other portions, the movement supporter 250 disposed at the uppermost storage position can be prevented from deviating from the first position fixation portion 227 when being moved to the operation position. When the movement supporter 250 disposed at the storage position in the uppermost end is pulled and moved, the greatest force can be generated. Herein, the second position fixation portion 257 of the movement supporter 250 can deviate from the first position fixation portion 227. However, in some implementations, the storage locking end 227a extends long, so the second position fixation portion 257 can stay in the storage locking end 227a even when deviating.

The storage locking end 227a can be provided on a first end portion of the first position fixation portion 227. A distance from the storage locking end 227a to a second end portion of the first position fixation portion 227 can be the entire length of the first position fixation portion 227. The entire length of the first position fixation portion 227 can be longer or equal to the movement distance of the movement supporter 250 and the connector assembly C. Accordingly, in the process in which the movement supporter 250 and the connector assembly C are moved, the second position fixation portion 257 can be continuously engaged with the first position fixation portion 227.

In some implementations, the second position fixation portion 257 has an elastic deformable structure. Therefore, the second position fixation portion 257 can be elastically deformed in the process in which the second position fixation portion 257 is engaged with the first position fixation portion 227. In some examples, the first position fixation portion 227 can have an elastic deformable structure. The first position fixation portion 227 has a cantilever structure, and the movement supporter 250 can be moved with the second position fixation portion 257 elastically deforming the first position fixation portion 227.

In some implementations, the storage fixation portion 227, 257 can have a structure in which the movement supporter 250 is press-fitted into the mounting base 210, not the elastic deformation structure. In some implementations, the movement supporter 250 can be assembled to the storage fixation portion 227, 257 to be turned, or have a latch structure. Otherwise, the movement supporter 250 can be fixed to the mounting base 210 through a separate fastener.

The mounting station 220 can include the mounting stopper 229. The mounting stopper 229 can interfere with the movement supporter 250 to limit the movement range of the movement supporter 250. The mounting stopper 229 can be provided with a cantilever structure in the mounting station 220. The mounting stopper 229 can have a cylindrical shape. The mounting stopper 229 can be disposed between the first guide 214 and the guide slot 225.

The mounting stopper 229 can interfere with the stopping holder 259 of the movement supporter 250. When the stopping holder 259 is brought into contact with the mounting stopper 229, the movement supporter 250 can no longer be moved. The figure as described above is illustrated in FIG. 17. The stopping holder 259 can be caught in a shape covering a surface of the mounting stopper 229. In some examples, a pair of mounting stoppers 229 can be provided. In some examples, the mounting stopper 229 can include one mounting stopper or three or more mounting stoppers.

The mounting base 210 can include the restraint maintaining part 230 at the opposite side of the mounting stopper 229. The restraint maintaining part 230 can enable the movement supporter 250 and the door connector 270 to remain fixed to the operation position. The restraint maintaining part 230 can fix the movement supporter 250 fixed to the operation position, and prevent the movement supporter 250 from being moved toward the storage position. A detailed structure of the restraint maintaining part 230 will be described below again.

The movement supporter 250 will be described with reference to FIGS. 19 and 20. The door connector 270 can be mounted to the movement supporter 250. The door connector 270 can be moved along the mounting station 220 with the movement supporter 250. The movement supporter 250 can be moved between the storage position and the operation position. The movement supporter 250 can remain fixed to the storage position and the operation position respectively.

A plurality of surfaces of the movement supporter 250 can be brought into close contact with a plurality of different surfaces of the mounting base 210. Then, the movement supporter 250 can be linearly moved while being stably seated on the mounting base 210. In some examples, the movement supporter 250 can maintain a state in close contact with the mounting base 210 at a lower surface, i.e., a surface facing the mounting station 220, and both side surfaces facing the first position fixation portion 227. Accordingly, the movement supporter 250 can be operated while being supported by the mounting base 210 in at least three different portions.

A frame of the movement supporter 250 can be formed of a supporter body 251. The supporter body 251 can have a flat plate structure. A first surface of the supporter body 251 can be a supporting board 253 on which the door connector 270 is seated. A second surface of the supporter body 251 can be brought into close contact with the seating surface 221 of the mounting base 210. The entire length of the supporter body 251 (a vertical length based on the drawing) can be shorter than or equal to the length of the mounting station 220.

The supporter body 251 can include a supporter fence 252. The supporter fence 252 can protrude while surrounding an edge of the supporter body 251. The supporter fence 252 can form a connector mounting space on one surface of the supporter body 251. An upper fence 252′ can be provided on an upper end of the supporter body 251. The upper fence 252′ can protrude more than the supporter fence 252.

The supporter body 251 can include the supporting board 253. The supporting board 253 can be disposed in a central portion of the surface of the supporter body 251. The door connector 270 can be seated on the supporting board 253. In the mounting process of the door connector 270, the door connector 270 can be assembled to a connector holder 262 while sliding on the supporting board 253.

The guide block 253a can be disposed in the supporting board 253. The guide block 253a can be recessed suitable to the shape of the door connector 270. On the other hand, the guide block 253a can protrude on a second surface of the supporting board 253. While the guide block 253a is inserted into the supporter guide groove 223, the movement supporter 250 can be moved. When the door connector 270 is mounted to the supporter body 251, the guide block 253a can guide the movement of the door connector 270.

Herein, the vertical length of the supporting board 253 can be longer than the vertical length of the door connector 270. Herein, the vertical length can be equal to the movement direction of the movement supporter 250. The door connector 270 can slide downward while being seated on an upper portion of the supporting board 253 to be mounted to the connector holder 262 described below. Therefore, the length of the supporting board 253 is preferably longer than the length of the door connector 270.

The supporter body 251 can include the wire fixation part 254. The wire fixation part 254 can guide a direction in which the door wire W2 connected to the door connector 270 extends. The wire fixation part 254 can have a kind of clip structure. The wire fixation part 254 can have a clip structure to fix the door wire W2 while covering both side portions thereof. In some examples, the wire fixation part 254 can be provided in a central portion of the upper fence 252′. A wire fixation hole 254a is open in a central portion of the wire fixation part 254, so the door wire W2 can pass through the wire fixation hole.

The wire fixation part 254 may be disposed on a vertical line Y1 same as the first guide 214. FIG. 15 illustrates the wire fixation part 254 disposed on the extension line Y1 same as the first guide 214. The wire fixation part 254 and the second guide 215 are not disposed on the same extension line Y1. Accordingly, the door wire W2 may extend vertically, i.e., in the movement direction of the movement supporter 250 and the door connector 270, while passing through the wire fixation part 254 to the first guide 214.

A first portion W2a of the door wire W2 that passes through the first guide 214 may pass through the second guide 215 and deviate from the extension line Y1 to be guided in a direction of an extension line Y2 biasing to one side. For reference, FIG. 24 illustrates the wire fixation hole 254a of the wire fixation part 254 and the first guide hole 214a of the first guide 214 aligned concentrically.

In the embodiment, the imaginary extension line Y1 between the wire fixation part 250 and the first guide 214 and the imaginary second extension line Y2 connecting the first guide 214 to the second guide 215 may form an acute angle therebetween. When an angle between the imaginary extension lines Y1, Y2 is an acute angle β, the first portion W2a (referring to FIG. 25) of the door wire W2 where largest external force is applied in the movement process of the door connector 270 may be prevented from being excessively twisted.

The first guide hole 214a and the second guide hole 215a may have different heights. Referring to FIG. 18, a height of the first guide hole 214a is formed to be higher than a height of the second guide hole. When the height of the first guide hole 214a is higher than the height of the second guide hole, the first portion W2a (referring to FIG. 25) of the door wire W2 where a largest external force is applied in the movement process of the door connector 270 may be prevented from being excessively twisted.

In some examples, since the movement supporter 250 can be moved, a distance between the wire fixation part 254 and the wire guide 213 can change. As described above, when the relative distance between the wire fixation part 254 and the wire guide 213 changes, a part of the door wire W2 can be bent.

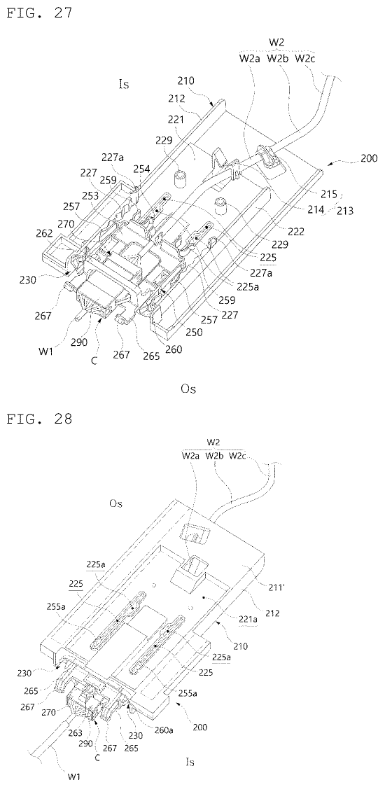

Comparing FIGS. 25 and 27, when the movement supporter 250 and the door connector 270 are located in the storage position (FIG. 25), the door wire W can be pushed toward the image acquisition module 100 (an upward direction based on the drawing) to be partially bent. Herein, a part of the door wire W2 between the first guide 214 and the second guide 215 can be referred to as the first portion W2a, and a part of the door wire W2 that passes through the second guide 215 can be referred to as a second portion W2b.

As illustrated in FIG. 25, when the door wire W is pushed toward the image acquisition module 100 (upward direction based on the drawing), a part that passes through the second portion W2b can be naturally bent, and the portion can be referred to as a third portion W2c. The extension direction of the door wire W to the second portion W2b can be fixed by the second guide 215. The second guide 215 can induce the second portion W2b in a direction far away from the window V, i.e., toward the edge of the door body. Therefore, even when the third portion W2c is bent, the door wire does not cross the window V.

On the other hand, as illustrated in FIG. 27, when the movement supporter 250 is moved to the operation position, the door wire W is unfolded and recovered from the bent state of the third portion W2c. Eventually, the second guide 215 can induce the portion where the bending of the door wire W starts to be moved as far away from the window V as possible.

The supporter body 251 can include the guide arm 255. The guide arm 255 can protrude from the surface of the supporter body 251 toward the seating surface 221 of the mounting base 210. The guide arm 255 can be inserted into the guide slot 225. When the guide arm 255 passes through the guide slot 225, the guide arm 255 is prevented from being separated from the mounting base 210. The guide arm 255 is moved along the guide slot 225, so the movement of the guide arm can be guided by the guide slot 225.

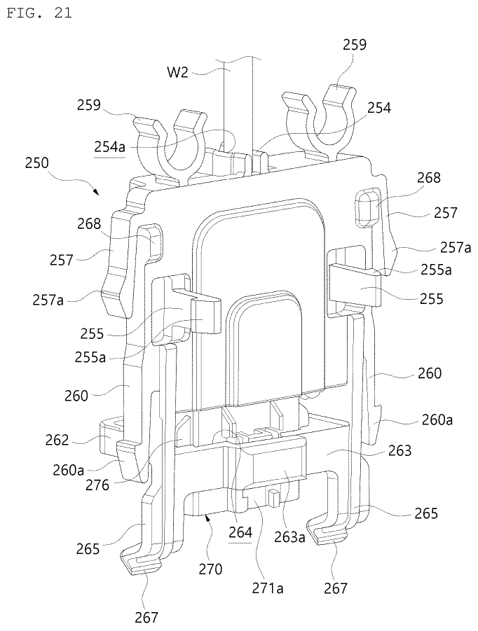

Referring to FIG. 21, one end of the guide arm 255 can include the guide head 255a. The guide head 255a can prevent the guide arm 255 from being removed from the guide slot 225. The guide head 255a can pass through the guide slot 225 through the slot entrance 225a of the guide slot 225. Since the thickness of the guide head 255a is thicker than other portions of the guide arm 255, when the guide arm 255 is moved along the guide slot 225 after passing through the slot entrance 225a, the guide arm 255 is prevented from being removed from the guide slot 225.

Referring to FIGS. 19 and 20, the supporter body 251 can include the second position fixation portion 257. The second position fixation portion 257 can be caught by the first position fixation portion 227, thereby fixing a position of the movement supporter 250. The second position fixation portion 257 can extend into a cantilever shape from the supporter body 251. The second position fixation portion 257 can be an elastic fixation arm having a cantilever shape in which a first end portion is a fixation end fixed on the surface of the supporter body 251 and a second end portion is a free end. Accordingly, the second position fixation portion 257 can be elastically deformed in the interference process with the first position fixation portion 227. For the elastic deformation, the free end of the second position fixation portion 257 can have a spreading form spaced apart from the surface of the supporter body 251. In some examples, the second position fixation portion 257 can be provided into a cantilever shape on either side surface of the supporter body 251.

One end of the second position fixation portion 257 can include a fixation end portion 257a. The fixation end portion 257a can be a portion relatively thicker than other portions in the second position fixation portion 257. The fixation end portion 257a can be fixed by being caught by the first position fixation portion 227 of the uneven shape. The fixation end portion 257a can have a shape engaged with the gear shape structure of the first position fixation portion 227.

The movement supporter 250 can include the stopping holder 259. The stopping holder 259 can interfere with the mounting stopper 229 provided on the mounting base 210, thereby limiting the movement range of the movement supporter 250. The stopping holder 259 can be provided on the upper end of the supporter body 251. More precisely, the stopping holder 259 can protrude upward from a surface of the upper fence. The stopping holder 259 can have a shape generally resembling a clip. In some examples, the movement supporter 250 can include the stopping holder 259 on either portion of the wire fixation part 254 with the wire fixation part 254 as the center. In some examples, only one stopping holder 259 can be provided, or the stopping holder 259 can be omitted. When the stopping holder 259 is omitted, the surface of the movement supporter 250 can directly interfere with the mounting stopper 229.

The stopping groove (not assigned with reference numeral) can be formed inside the stopping holder 259. A part of an upper end of the stopping groove can be open. The mounting stopper 229 can be inserted through the open portion. The stopping groove can cover the surface of the mounting stopper 229 provided on the mounting base 210. Accordingly, the mounting stopper 229 can limit the depth at which the movement supporter 250 and the door connector 270 are inserted.

The movement supporter 250 can include a supporter restraint arm 260. The supporter restraint arm 260 can protrude from the movement supporter 250. The supporter restraint arm 260 can have a cantilever structure in which a first end portion is a fixation end portion fixed to a side surface of the supporter body 251 and a second end portion is a free end portion. Therefore, the supporter restraint arm 260 can be elastically deformed. Herein, for the elastic deformation, the free end portion of the supporter restraint arm 260 can have a spreading structure spaced apart from the side surface of the movement supporter 250. The supporter restraint arm 260 can be fixed to the restraint maintaining part 230 of the mounting base 210. When the supporter restraint arm 260 is fixed to the restraint maintaining part 230, the movement supporter 250 and the connector assembly C can remain fixed to the operation position.

Reference numeral 260a is a restraint head 260a provided at the supporter restraint arm 260. The restraint head 260a can be a portion substantially caught by the restraint maintaining part 230 and fixed. The supporter restraint arm 260 including the restraint head 260a can have a kind of hook structure.

Referring to FIG. 17, a distance of the supporter restraint arm 260 protruding from the side surface of the movement supporter 250 can be shorter than the second position fixation portion 257. In other words, the second position fixation portion 257 can protrude in a direction further spreading from the side surface of the movement supporter 250 than the supporter restraint arm 260. Then, the supporter restraint arm 260 can be prevented from interfering with the first position fixation portion 227 in the movement process of the movement supporter 250.

The movement supporter 250 can include the connector holder 262. The connector holder 262 can fix the door connector 270 to the movement supporter 250. In other words, the connector holder 262 can enable the movement supporter 250 to transfer the door connector 270. The connector holder 262 can be provided below the supporting board 253. The connector holder 262 can have roughly a kind of rectangular frame structure surrounding a surface of the door connector 270. The mounting hole 264 is provided in a central portion of the connector holder 262, and the door connector 270 can be disposed in the mounting hole 264.

The connector holder 262 can include a connector support end 263. The connector support end 263 can make the mounting hole 264 with the connector holder 262. The connector support end 263 can be disposed below the guide block 253a. When the connector holder 262 surrounds a first surface and both side surfaces of the door connector 270, the connector support end 263 can support a second surface of the door connector 270. Reference numeral 263a indicates a support end recessed part that is recessed to match the shape of the door connector 270.

Referring to FIG. 20, when the door connector 270 is mounted to the mounting hole 264, the connector lance part 275 of the door connector 270 can pass through the mounting hole 264 and be fixed by being caught by the opposite side portion of the mounting hole 264. Then, the door connector 270 is prevented from being separated in the opposite direction, i.e., an upward direction based on FIG. 20.

An edge portion of the mounting hole 264 can include a holding end portion (referring to FIG. 19). The holding end portion 264a can be a portion by which the connector protrusion 276 of the door connector 270 is caught. When the connector protrusion 276 is caught by the holding end portion 264a, the door connector 270 is no longer moved in the mounting direction, i.e., in a downward direction based on FIG. 20. Eventually, the door connector 270 can be fixed in the opposite directions.

The movement supporter 250 may include an operation lever 265. The operation lever 265 may be a portion operated when a locked state in which the movement supporter 250 is locked by the restraint maintaining part 230 of the mounting base 210. When the restraint head 260a of the supporter restraint arm 260 is locked by being caught by the restraint maintaining part 230 into the locked state, the operation lever 265 should be changed from the locked state to the released state.

The operator can operate the operation lever 265 to make the movement supporter 250 into a movable state. When the operator lifts the operation lever 265, the entire movement supporter 250 can be turned at a predetermined angle. In the above process, a locked state in which the restraint head 260a of the supporter restraint arm 260 is caught by the restraint maintaining part 230 of the mounting base 210 can be released. For reference, based on the front space of the lower door 70, when the operator pushes the operation lever 265 toward the storage space, the entire movement supporter 250 can be turned by a predetermined angle. Herein, as described above, the guide head 255a and the edge of the guide slot 225 are spaced apart from each other, so the guide head 255a can be prevented from interfering with a bottom surface of the mounting base 210 when the movement supporter 250 is turned.

For convenience of operation, in some implementations, the movement supporter 250 can include a pair of operation levers 265 protruding from a lower end portion of the movement supporter 250. More specifically, a first end of the pair of operation levers 265 can be connected to the lower end of the movement supporter 250, and a second end thereof can protrude downward, i.e., toward the connector inlet 73a of the connector storage portion CM. The operation lever 265 can have a kind of cantilever structure.

The operation lever 265 can include the gripping end 267. The gripping end 267 can have a shape bent from the second end of each operation lever 265. The gripping end 267 can have roughly a “U” shape. Accordingly, the operator can easily grip the gripping end 267 and lift the operation lever 265. The process in which the operator lifts the operation lever 265 to release the locked state will be described below again.

Referring to FIG. 22, the movement supporter 250 and the connector assembly C can be assembled to the mounting base 210. Herein, the movement supporter 250 and the connector assembly C can be disposed at the storage position. Therefore, not only the movement supporter 250 but also the connector assembly C may not be exposed downward of the connector storage portion CM (leftward direction based on the drawing). Herein, the second position fixation portion 257 of the movement supporter 250 can be caught by the storage locking end 227a in the first position fixation portion 227 of the mounting base 210. Therefore, the movement supporter 250 and the connector assembly C may not be moved in a direction toward the operation position (leftward direction based on the drawing) and remain fixed. Reference numeral 221a indicates a movement space having a shape in which a part of the mounting base 210 is recessed so that the guide head 255a can be moved.

Herein, as illustrated in the drawing, the guide head 255a provided in the guide arm 255 of the movement supporter 250 can pass through the guide slot 225 of the mounting base 210. Therefore, the movement supporter 250 and the connector assembly C can be prevented from being separated in a direction (upward direction based on the drawing) perpendicular to the movement direction of the movement supporter 250. Since the movement arm is inserted into the guide slot 225, the movement of the movement supporter 250 can also be guided.

Referring to FIG. 23 without the movement supporter 250 and the connector assembly C, the movement supporter 250 can be moved in the arrow direction. In some examples, first, the operator can access the connector inlet 73a to lift the gripping end 267 of the operation lever 265. The lifting direction can be a direction (upward direction based on the drawing) perpendicular to the movement direction of the movement supporter 250.

FIG. 24 illustrates the movement supporter 250 fixed to the mounting base 210. As illustrated in the drawing, the guide head 255a of the guide arm 255 can be inserted into the guide slot 225. Accordingly, vertical movement (based on the drawing) of the movement supporter 250 can be limited. At the same time, the second position fixation portion 257 can be caught by the first position fixation portion 227. Since either side surface of the movement supporter 250 are surrounded by the guide fence 212, transverse movement (based on the drawing) can also be limited. Eventually, the movement supporter 250 and the connector assembly C can be fixed in all directions at the storage position.

For reference, in FIG. 24, reference numeral 268 indicates a supporter foot provided at the movement supporter 250. The supporter foot 268 may protrude on a lower surface of the movement supporter 250 facing the surface of the mounting base 210. The supporter foot 268 may reduce a contact area between the movement supporter 250 and the mounting station 220, thereby reducing a friction force when the movement supporter 250 is moved. Referring to FIG. 21, the supporter foot 268 may protrude in a curved surface shape from a surface of the movement supporter 250. As another example, the supporter foot 268 may have an elongated structure extending long in a longitudinal direction of the movement supporter 250, i.e., the movement direction of the movement supporter 250.

FIGS. 25 and 26 illustrate the movement supporter 250 and the connector assembly C in the storage position at different angles. As illustrated in the drawings, the movement supporter 250 and the connector assembly C can be spaced apart upward from the lower end of the mounting base 210. The mounting stopper 229 can be caught by the stopping holder 259, so the movement supporter 250 can no longer be moved upward. The second position fixation portion 257 can be caught by the storage locking end 227a provided at the first end of the first position fixation portion 227. Furthermore, the guide head 255a of the guide arm 255 can be in a state of being inserted into the guide slot 225.

In this state, when the movement supporter 250 is moved in the arrow direction, the connector assembly C can also be moved with the movement supporter 250. When the movement supporter 250 starts to be moved from the storage position, the second position fixation portion 257 should pass over the storage locking end 227a. When the operator pulls the movement supporter 250, the second position fixation portion 257 is elastically deformed in a direction toward the surface of the movement supporter 250 and can pass over the storage locking end 227a. Herein, the operator can access the movement supporter 250 through the connector inlet 73a (referring to FIG. 10) and pull the operation lever 265.

FIGS. 27 and 28 illustrate the movement supporter 250 and the connector assembly C moved and disposed in the operation position. The movement of the movement supporter 250 and the connector assembly C can be guided by the guide arm 255 inserted in the guide slot 225. In the movement process, the second position fixation portion 257 can continuously pass the first position fixation portion 227. Herein, the second position fixation portion 257 is engaged with the continuous uneven part of the first position fixation portion 227, thereby repeating elastic deformation and recovery of an original form.

When the movement supporter 250 and the connector assembly C are moved to the operation position, the entire relative connector 290 and a part of the door connector 270 can be exposed outward of the mounting base 210. The protruding portion can be disposed at the connector inlet 73a so the operator can check with the naked eye.

When the movement supporter 250 is moved to the operation position, the movement supporter 250 can be fixed at the operation position. Herein, fixing means a state of the movement supporter 250 not arbitrarily moved by an external force and can be a locked state of the movement supporter 250. When the movement supporter 250 is in the locked state, the connector assembly C can also be in the locked state. Therefore, an operation of assembling or separating the connector assembly C can be easily performed.

Specifically, in some examples, the door connector 270 can be mounted to the movement supporter 250 and moved together, so that the door connector 270 can be moved while facing in a constant direction. More specifically, the assembly surface 271a of the door connector 270 can be moved while facing the connector inlet 73a. Accordingly, when the door connector 270 is moved to the operation position, the assembly surface 271a can be exposed outward of the connector inlet 73a, and the assembling/separating operation of the connector can be easily performed.

When the movement supporter 250 is moved to the operation position, the restraint head 260a of the supporter restraint arm 260 can maintain the locked state in which the restraint head 260a can be caught by the restraint maintaining part 230 of the mounting base 210. FIG. 29 illustrates the movement supporter 250 and the connector assembly C, the movement supporter 250 and the connector assembly C being moved to the operation position and the assembly surface 271a of the door connector 270 and the operation lever 265 being exposed outward of the mounting base 210. For reference, the relative connector 290 is omitted in FIG. 29.

Herein, the restraint head 260a of the supporter restraint arm 260 is caught by the restraint maintaining part 230 provided on either end of the mounting base 210. Accordingly, the movement supporter 250 may not be returned to the storage position and remain fixed at the operation position. In this state, when the relative connector 290 is assembled to the door connector 270, the door connector 270 maintains the fixed state, and connector assembly can be easily performed.

More specifically, the restraint head 260a of the supporter restraint arm 260 may be caught by a locking step 231 (referring to FIG. 22) provided at the restraint maintaining part 230. The locking step 231 may include a locking surface 232. The locking surface 232 may be a flat surface structure toward the connector inlet 73a. The restraint head 260a is fixed by being substantially caught by the locking surface 232. When the restraint head 260a of the supporter restraint arm 260 deviates from the locking surface 232, the locked state may be removed.

The connector inlet 73a may include a mounting cover. The mounting cover may block the connector inlet 73a, thereby covering the connector assembly C. More specifically, the mounting cover may allow the pass of the main wire W1 extending from the relative connector 290, and cover the lower portion of the relative connector 290.

FIG. 29 illustrates the sixth embodiment of a connector module 700 constituting the door for a home appliance according to the present disclosure. The structure overlapped with the above-described embodiment is assigned with the same reference numeral in the 700's, and a detailed description will be omitted.

The connector storage portion CM may be provided in the lower door 70. The connector storage portion CM may be provided in the door body in the lower door 70. The connector storage portion CM may be provided in the front frame part 72 constituting a frame of the door body. The front side plates 72a, i.e., a part of the front frame part 72, may constitute both side surfaces of the door body. As described above, the connector storage portion CM may be provided in a front side plate 72a constituting both side surfaces of the door body.

As illustrated in FIG. 29, the connector module 700 may stand in the connector storage portion CM. The connector module 700 is not seated on the front panel Ga, and may be disposed in the connector storage portion CM provided in the front side plate 72a. A transverse width of the connector module 700 may be formed equal to or smaller than the width of each front side plate 72a. Since the connector storage portion CM is provided at the lower end of the front frame part 72, the fabricator can easily access the connector module 700 through the connector inlet 73a of the lower door 70.

Herein, each front side plate 72a has roughly a concavely “⊂” shape, and the connector storage part CM may be provided in the concave portion. The connector storage part CM may be integrally formed with the front side plate 72a. Accordingly, the door connector 770 may be linearly moved along the concave portion of the front side plate 72a.

Although not shown in the drawing, the movement supporter 750 may be moved transversely with respect to the mounting base 710. Based on FIG. 29, the movement supporter 750 may be moved in the transverse direction, i.e., the width direction of the lower door 70, not the vertical direction.

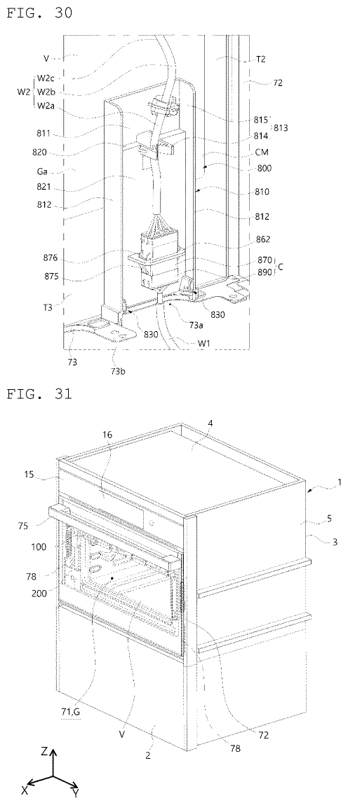

Next, FIG. 30 illustrate the seventh embodiment of a connector module 800 constituting the door for a home appliance according to the present disclosure. The structure overlapped with the above-described embodiment is assigned with the same reference numeral in the 800's, and a detailed description will be omitted.

As shown in FIG. 30, the connector module 800 can be disposed in the lower door 70. The connector module 800 can be disposed in the connector storage portion CM provided at the lower portion of the lower door 70. The connector inlet 73a can be open in a lower portion of the lower door 70. A lower portion of the connector module 800 can be disposed toward the connector inlet 73a.

The connector assembly C can be stored in the connector module 800. The connector assembly C can be a part of the connector module 800. When the connector assembly C is disposed in the connector module 800, two wires can be fixed while extending in different directions. More specifically, the door wire W2 of the door connector 870 constituting the connector assembly C can extend to the inside space of the lower door 70. The main wire W1 of the relative connector 890 constituting the connector assembly C can extend to the outside space of the lower door 70 through the connector inlet 73a.

The connector module 800 can include the mounting base 810. The mounting base 810 can be fixed to the connector storage portion CM. The mounting base 810 can guide the movement of the connector assembly C. Since the mounting base 810 is fixed, the mounting base 810 can be relatively moved for the connector assembly C.

The mounting base 810 can guide the movement of the connector assembly C. The mounting base 810 is fixed in the connector storage portion CM, thereby preventing the connector assembly C from being also separated from the connector storage portion CM. The mounting base 810 can guide an extension direction of the door wire W2 as described below.

Describing the mounting direction of the mounting base 810, the rear surface of the mounting base 810 can face the front space of the lower door 70. When viewed from the front space of the lower door 70, the connector assembly C disposed on a front surface of the mounting base 810 can be covered by the mounting base 810. Since the connector module 800 including the mounting base 810 is disposed outside the window V, the connector module 800 can be covered by an edge portion of the lower door 70. In some examples, even when the connector module 800 crosses a part of the window V, the connector assembly C is covered by the mounting base 810 and is prevented from exposing outward.

The door wire W2 can extend upward of the mounting base 810. The main wire W1 can extend downward of the mounting base 810. The mounting base 810 is disposed closer to the wire tube 83 provided in the side frame 80 (referring to FIG. 10), so an exposure area of the main wire W1 can be reduced.

The structure of the mounting base 810 will be described in detail. A frame of the mounting base 810 can be formed of a base body 811 of a flat plate structure. The mounting station 820 can be disposed on a first surface of the base body 811. The second surface of the base body 811 can be brought into close contact with the surface of the front panel Ga as a fixation surface. For example, the second surface of the base body 811 can adhere to the surface of the front panel Ga as a fixation surface. In some examples, the base body 811 can be fixed to the door frame 72, 77, 80, 90, not a surface of the front panel Ga.

The base body 811 can include a wire guide 813. The wire guide 813 can guide a direction in which the door wire W2 extends. The wire guide 813 can protrude from the base body 811. The wire guide 813 covers the door wire W2 so that the door wire W2 extends in a preset direction. In some examples, the wire guides 813 can include a first guide 814 and a second guide 815.

The first guide 814 may be disposed at an edge of the mounting station 820. The second guide 815 may deviate from the mounting station 820 and be disposed outside the mounting station 820. The door wire W2 may extend toward the image acquisition module 100 while passing through the first guide 814 and the second guide 815 in order.

The first guide 814 and the second guide 815 may be disposed to be offset from each other based on a stored direction of the door connector 870 (vertical direction based on FIG. 30). The first guide 814 may be disposed on a position passing through a central portion of the door connector 870.

FIG. 31 illustrates another example of a home appliance according to the present disclosure. As illustrated in the drawing, the home appliance can be a built-in type of home appliance. For example, the home appliance can be a cooking appliance installed in a built-in manner. As illustrated in the drawing, the cooking appliance can be installed in kitchen furniture 1, etc., and the front surface of the cooking appliance can only be exposed forward. Herein, the lower door 70 and the operating part 16 can be included on the front surface of the cooking appliance. Reference numeral 16 indicates a display part exposed from a front surface of the operating part 16. The image acquisition module 100 and the connector module 200 which are described above can be disposed in the lower door 70.

Although the preferred implementations of the present disclosure have been described for illustrative purposes, those skilled in the art will appreciate that various modifications, additions and substitutions are possible, without departing from the scope and spirit of the present disclosure as disclosed in the accompanying claims. Therefore, the preferred implementations described above have been described for illustrative purposes, and should not be intended to limit the technical spirit of the present disclosure, and the scope and spirit of the present disclosure are not limited to the implementations. The protective scope of the present disclosure should be interpreted by the accompanying claims, and all technical spirits within the equivalent scope should be interpreted as being included in the scope and spirit of the present disclosure.

What is claimed is:

1. A door for an appliance, the door comprising:
a door body configured to be disposed at a front of a storage space of the appliance;
an electronic component disposed in the door body;
a connector module disposed in the door body; and
a door wire that electrically connects the connector module to the electronic component,
wherein the connector module comprises:
a mounting base disposed inside the door body, and
a door connector mounted to the mounting base and connected to the door wire, and
wherein the mounting base comprises a wire guide that covers at least a portion of the door wire and defines an extension direction of the door wire.

2. The door of claim 1, wherein the door connector is configured to move along the mounting base, and
wherein a distance between the door connector and the wire guide changes as the door connector moves along the mounting base.

3. The door of claim 1, wherein the wire guide is disposed between the electronic component and the door connector.

4. The door of claim 1, wherein the wire guide comprises:
a first guide that protrudes from a surface of the mounting base; and
a second guide spaced apart from the first guide, the second guide being disposed closer to the electronic component than the first guide.

5. The door of claim 4, wherein the door connector is configured to move along the mounting base, and
wherein the first guide and the second guide are spaced apart from each other in a direction different from a movement direction of the door connector.

6. The door of claim 4, wherein the second guide is disposed closer to an edge of the door body than the first guide.

7. The door of claim 4, wherein the first guide defines a first guide hole at a center portion thereof,
wherein the second guide defines a second guide hole at a center portion thereof,
wherein the first guide hole and the second guide hole are open in directions different from each other, and
wherein the door wire passes through the first guide hole and the second guide hole.

8. The door of claim 7, wherein a height of the first guide hole from the surface of the mounting base is greater than a height of the second guide hole from the surface of the mounting base.

9. The door of claim 4, wherein the first guide comprises a pair of guide hooks that support opposite surfaces of the door wire, and
wherein the first guide defines a first guide hole between the pair of guide hooks.

10. The door of claim 4, wherein the second guide defines a wire insertion port that is open toward an edge of the door body and receives the door wire.

11. The door of claim 1, wherein the connector module further comprises a movement supporter that is movably disposed at the mounting base, and
wherein the door connector is coupled to the movement supporter and configured to move together with the movement supporter relative to the mounting base.

12. The door of claim 11, wherein the connector module further comprises a wire fixation part disposed at the movement supporter and configured to guide the door wire, and
wherein a distance between the wire fixation part and the wire guide changes as the movement supporter moves relative to the mounting base.

13. The door of claim 12, wherein the wire guide comprises a first guide and a second guide that are spaced apart from each other,
wherein the wire fixation part and the first guide are arranged along an imaginary central line extending in a movement direction of the door connector, and
wherein the second guide is disposed at a position deviating from the imaginary central line.

14. The door of claim 13, wherein the wire fixation part and the first guide are arranged along an imaginary first extension line, and
wherein the first guide and the second guide are arranged along an imaginary second extension line that defines an acute angle with respect to the imaginary first extension line.

15. The door of claim 13, wherein the connector module further comprises a mounting station that is disposed at the mounting base and protrudes from a surface of the mounting base,
wherein the door connector is configured to move relative to the mounting station, and
wherein the first guide is disposed at the mounting station, and the second guide is disposed outside the mounting station.

16. The door of claim 1, wherein the electronic component comprises:
a main unit that extends in a first direction; and
a connection unit that is connected to the main unit and extends in a second direction different from the first direction,
wherein the connection unit defines a connection hole that is open toward the connector module, and
wherein the door wire extends from the wire guide toward the connection hole.

17. The door of claim 1, wherein the door body comprises a door panel disposed at a central portion of the door body, the door panel comprising a window through which the storage space is visible,
wherein the door body defines an indoor space including an installation region disposed around an outer portion of the window, and
wherein the connector module is disposed in the installation region.

18. The door of claim 17, wherein the wire guide comprises a first guide and a second guide that are spaced apart from each other, and
wherein the second guide is disposed farther from the window than the first guide.

19. A door for an appliance, the door comprising:
a door body configured to be disposed at a front of a storage space of the appliance, the door body accommodating an electronic component therein; and
a connector module disposed in the door body and electrically connected to the electronic component through a door wire,
wherein the connector module comprises a wire guide that covers at least a portion of the door wire and is configured to guide the door wire to be bent at a position between the connector module and the electronic component.

20. An appliance comprising:
a main body that defines a storage space therein;
a door body that is disposed at a front of the storage space and accommodates an electronic component therein; and
a connector module disposed in the door body and electrically connected to the electronic component through a door wire,
wherein the connector module comprises:
a mounting base disposed inside the door body, and
a door connector mounted to the mounting base and connected to the door wire, and
wherein the mounting base comprises a wire guide that covers at least a portion of the door wire and defines an extension direction of the door wire.
